(19) United States
(12) Patent Application Publication
(10) Pub. No.: US 2011/0033794 A1
(43) Pub. Date: Feb. 10, 2011

(54) TONER, METHOD FOR PRODUCING THE SAME, AND PROCESS CARTRIDGE

(76) Inventors: Naohiro WATANABE, Shizuoka (JP); Naohito SHIMOTA, Shizuoka (JP); Yasuaki IWAMOTO, Shizuoka (JP); Masana SHIBA, Shizuoka (JP); Satoshi KOJIMA, Shizuoka (JP); Masaki WATANABE, Shizuoka (JP); Tsuneyasu NAGATOMO, Shizuoka (JP); Hyo SHU, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/848,508

(22) Filed: Aug. 2, 2010

(30) Foreign Application Priority Data
Aug. 5, 2009 (JP) 2009-182197
Aug. 10, 2009 (JP) 2009-186074
Sep. 8, 2009 (JP) 2009-206976
Sep. 14, 2009 (JP) 2009-211506
Oct. 22, 2009 (JP) 2009-243143

(51) Int. Cl. G03G 9/00; G03G 21/18

(52) U.S. Cl. 430/105; 399/111

(57) ABSTRACT

A toner containing a binder, a colorant, and a wax having a molecular chain consisting of C—H bond and C—C bond, wherein the mass reduction of the wax at 165° C. is 10% by mass or less, and the total amount of the wax in the toner measured by a DSC method is 1% by mass to 8% by mass, wherein a ratio, Sbet/SF, of a BET specific surface area (Sbet) of the toner to an average circularity (SF) of the toner is 1.0 m²/g or more to less than 3.6 m²/g, wherein the toner is obtained through a process which contains at least emulsifying or dispersing a toner material liquid in an aqueous medium containing a surfactant, and wherein the toner material liquid is a liquid containing toner-forming materials which contains at least the binder, the colorant and the wax.

### BACKGROUND OF THE INVENTION

1. Field of the Invention

The present invention relates to a toner used in an electrophotographic image forming apparatus such as a copier, printer, facsimile, and a method for producing the toner, and a process cartridge having a developing unit containing the toner.

2. Description of the Related Art

In recent years, in the field of an image forming technology utilizing electrophotography, there is an ever-increasing competition in the development of an apparatus for color image formation that can realize high-speed image formation and, at the same time, can yield a color image having high image quality (technology for forming high grade color image). For this reason, in order to form a full color image at a high speed, the so-called tandem system has become extensively adopted in methods for image formation. In the tandem system, a plurality of electrophotographic photoconductors (otherwise referred to as photoconductor or photoconductors, simply) are tandemly arranged. Images for respective color components are formed in respective electrophotographic photoconductors. The formed images are superimposed on top of each other on an intermediate transfer medium, and the superimposed images are transferred at a time on a recording medium (for example, Japanese Patent Application Laid-Open (JP-A) Nos. 07-209952 and 2000-075551).

The use of the intermediate transfer medium is effective in preventing the transfer of smear directly onto a recording medium such as paper when smear has occurred on the electrophotographic photoconductors during development. Since, however, in the system using the intermediate transfer medium, two transfer steps, that is, a step of transfer from the electrophotographic photoconductor to the intermediate transfer medium (primary transfer) and a step of transfer from the intermediate transfer medium to a recording medium to give a final image (secondary transfer), are performed, the transfer efficiency is lowered.

On the other hand, in addition to the above problem, there is a demand for the formation of a high-quality full color image. To meet this demand, a developer has been designed for improving an image quality. In order to cope with the demand for the improved image quality, particularly in a full color image, there is an increasing tendency toward the production of a toner having a smaller particle diameter, and studies have been made on faithful reproduction of a latent image to be formed on a photoconductor. Regarding the reduction in particle diameter, a process for producing a toner by a polymerization process has been proposed as a method that can regulate the toner so as to have a desired shape and surface structure (for example, Japanese Patent No. (JP-B) 3640918, Japanese Patent Application Laid-Open (JP-A) No. 06-250439).

In the toner produced by the polymerization process, in addition to the control of the diameter of toner particles, the shape of toner particles can also be controlled. A combination of this technique with a particle size reduction can improve the reproducibility of dots and narrow lines, and can reduce pile height (image layer thickness), whereby an improvement in image quality can be expected. When a small-diameter toner is used, however, non-electrostatic adhesion between the toner particle and the electrophotographic photoconductor or between the toner particle and the intermediate transfer medium is increased. Accordingly, the transfer efficiency is likely to be further lowered. This leads to such an unfavorable phenomenon that, when the small-diameter toner is used in a high-speed full-color image forming apparatus, the transfer efficiency, particularly in the secondary transfer is significantly lowered. The reason for this is that the degree of difficulty of transfer is increased because, due to the reduction in particle diameter of the toner, the non-electrostatic adhesion to the intermediate transfer medium per toner particle is increased, a plurality of color toners are present in a superimposed state in the secondary transfer, and, due to an increase in speed, the period of time, for which the toner particle undergoes a transfer electric field in a nip portion in the secondary transfer, is decreased.

Further increasing the transfer electric field in the secondary transfer is considered effective in overcoming the above problem. However, when the transfer electric field is excessively increased, electric discharge occurs upon separating a recording medium from the intermediate transfer medium, decreasing the transfer efficiency disadvantageously. Accordingly, there is a limitation on this technique. Prolonging the period of time for which the toner particle undergoes the transfer electric field by increasing the width of the nip portion in the secondary transfer is also considered. In a contact-type voltage application system using a bias roller and the like, in order to increase the nip width, only any one of a method in which the contact pressure of the bias roller is increased, and a method in which the roller diameter of the bias roller is increased, can be adopted. Increasing the contact pressure has a limitation from the viewpoints of image quality, and increasing the roller diameter has a limitation from the viewpoint of a reduction in size of the apparatus. In a non-contact-type voltage application system using a charger or the like, the nip width in the secondary transfer should be increased, for example, by increasing the number of chargers. Accordingly, this also has a limitation. For the above reason, it can be said that, particularly in high-speed machines, it is practically impossible to increase the nip width so as to obtain transfer efficiency higher than that in the present stage.

On the other hand, a method has been proposed in which the type and addition amount of additives are regulated (particularly, additives having a large particle diameter is added) as a method that reduces the non-electrostatic adhesion between a toner particle and an electrophotographic photoconductor or between the toner particle and an intermediate transfer medium (for example, JP-A No. 2001-066820 and JP-B No. 3692829). According to this method, by virtue of the non-electrostatic adhesion reduction effect, the toner particle can realize improvement in transfer efficiency. Further, in this method, additional effects such as stability of development and improvement in cleaning effect can be attained.

The above-described toner particle can improve the transfer efficiency of the image forming apparatus at an early stage. However, when the toner continues to receive mechanical stress, for example, is subjected to long-term stirring in a developing unit in the image forming apparatus, the additive is embedded in toner base particles or adhered to minute irregularities in the toner particle surface. As a result, the additive cannot exhibit the adhesion reduction effect, and thus, the transfer efficiency of the image forming apparatus may decrease. Particularly in the case of high speed devices, toner particles are intensively stirred in the developing unit to receive large mechanical stress. This accelerates embedding and invasion of the additive in the toner base particles. Thus, it is estimated that the transfer efficiency decreases at a relatively early stage. Therefore, in order to maintain consistent, high transfer efficiency for a long term, it is necessary to control surface properties of toner so that the additive can exist on the toner surface without being embedded or invaded in the toner base particles, even though the toner surface receives mechanical stress in the high speed devices.

Moreover, an electrophotographic image forming method has been increasingly applied to the fields of printing large images at high speeds, such as offset printing. In the electrophotographic system, it is important to fix a toner image on a recording medium with as low energy as possible. On the other hand, it is important for an image forming toner to be fixed at lower temperatures and to be prevented form involving hot offset at high temperatures. Thus, there are some proposals for decreasing the fixing temperature by using a polyester resin, which is advantageous in low temperature fixing (for example, Japanese Patent (JP-B) No. 3376019). Alternatively, as a method for preventing the hot offset resistance, it has been known that a polymeric binder resin is introduced into the toner so as to control toner viscoelasticity, or that a releasing agent such as a wax is used to enhance the toner in releasing ability from the fixing member. For example, as to the releasing agent, as described in the above-described technique, some proposed releasing agents contain a paraffin wax, and other proposed releasing agents are defined by a DSC method in terms of the range of their melting point. Most of these releasing agents contribute to improvement of releasing ability. As described above, in the high speed printing field, even after images with large image area have been printed in a large amount, high quality images comparable to the images at an early stage are demanded. On the other hand, it has been found that, when the conventionally proposed wax is used in an electrophotographic image forming apparatus for large volume printing, highly volatile paraffin wax contaminates various members of the image forming apparatus or a transfer medium.

For example, Japanese Patent Application Laid-Open (JP-A) No. 2005-331925 discloses that the storage stability, carrier spent, or photoconductor filming resistance are improved by using a wax defined regarding its mass reduction during heating at 220° C. Even though the defined mass reduction at 220° C. is not satisfied, the above-described problems may not occur depending on the type of the wax selected or the type of the toner production method used (e.g., aqueous granulation). Even when the mass reduction properties are satisfied, members are contaminated at high speed printing, and the separation ability of a recording medium at high speed printing is not sufficient. Moreover, when a paraffin wax having a high melting point is used, it becomes difficult to obtain a desired releasing ability, causing decrease in image quality, for example, causing hot offset or poor glossiness. Only by defining the melting point of the paraffin wax, the contamination in the image forming apparatus is not prevented and a desired fixing ability is not ensured. Most images printed at high speed are full color images having large proportion of image area, and achievement of both releasing ability using a wax and no contamination inside the apparatus is most important in order to surely separate a heating medium from a transfer medium at high speed in a fixing step.

JP-A No. 2006-195040 and other literatures have proposed techniques in which microcrystalline wax is used to solve image unevenness upon fixation so as to form a highly uniform image. In this technique, for the purpose of improving image unevenness, an endothermic peak of the wax and a half-value width of the endothermic peak are defined. This improves image unevenness, but the melting point of the wax is high, which is disadvantageous to low-temperature fixing ability. Furthermore, even though the endothermic peak of the wax is decreased in view of the low-temperature fixing ability, there remains a problem in the separation ability of paper as a recording medium from a roller as a fixing unit at a high temperature.

### BRIEF SUMMARY OF THE INVENTION

An object of the present invention is to provide a toner which is excellent in releasing ability upon low-temperature fixing, causes less filming, decreases the amount of volatile matter upon fixing, has both desired low-temperature fixing ability and desired heat resistant storage stability, and both desired low-temperature fixing ability and desired separation ability of paper from a roller upon high temperature fixing, a method for producing the toner, and a process cartridge.

Means for solving the problems are as follows.

<1> A toner containing a binder, a colorant, and a wax having a molecular chain consisting of C—H bond and C—C bond, wherein the mass reduction of the wax at 165° C. is 10% by mass or less, and the total amount of the wax in the toner measured by a DSC method is 1% by mass to 8% by mass, wherein a ratio, Sbet/SF, of a BET specific surface area (Sbet) of the toner to an average circularity (SF) of the toner is 1.0 m²/g or more to less than 3.6 m²/g, wherein the toner is obtained through a process which includes at least emulsifying or dispersing a toner material liquid in an aqueous medium containing a surfactant, and wherein the toner material liquid is a liquid containing toner-forming materials which contain at least the binder, the colorant and the wax.
<2> The toner according to <1>, wherein the wax has a melting point of 50° C. to 90° C.
<3> The toner according to <2>, wherein the wax has a melting point of 52° C. to 77° C.
<4> The toner according to any of <1> to <3>, wherein the wax in the toner has a melt viscosity at 140° C. of 6 mPa·s to 15 mPa·s.
<5> The toner according to any of <1> to <4>, wherein the mass reduction of the wax at 165° C. is 3% by mass or less.
<6> The toner according to any of <1> to <5>, wherein the mass reduction of the wax at 165° C. is 2.2% by mass or less.
<7> The toner according to any of <1> to <6>, wherein the wax is microcrystalline wax.
<8> The toner according to any of <1> to <7>, further containing 40% by mass to 80% by mass of a wax dispersant relative to the wax.
<9> The toner according to any of <1> to <8>, wherein the toner-forming materials contain a binder resin or a precursor of the binder resin as a component of the binder.
<10> The toner according to <9>, wherein the precursor of the binder resin is a compound containing an active hydrogen group and a polymer reactive with the active hydrogen group, and the toner contains a reaction product obtained by reacting the compound with the polymer in the emulsifying or dispersing the toner material liquid in the aqueous medium.
<11> The toner according to any of <9> to <10>, wherein the toner-forming materials contain a polyester resin as the binder resin.
<12> A process cartridge containing a latent electrostatic image bearing member, and a developing unit, wherein the latent electrostatic image bearing member and the developing unit are integrally supported, and the process cartridge is detachably mounted to a main body of an image forming apparatus, wherein the developing unit contains the toner according to any of <1> to <11>, which is supplied to a latent electrostatic image on the latent electrostatic image bearing member so as to form a toner image.
<13> A method for producing the toner according to any of <1> to <11>, containing: emulsifying or dispersing a toner material liquid in an aqueous medium containing a surfactant so as to form a toner dispersion liquid; and heating the toner dispersion liquid at a temperature (T1) of 45° C. to 90° C. so as to treat a surface of a toner particle.
<14> The method for producing a toner according to <13>, wherein, in the heating, the temperature (T1) of the toner dispersion liquid at 45° C. to 90° C. is held for 1 minute to 1 hour.
<15> The method for producing a toner according to any of <13> to <14>, wherein, in the heating, the concentration of the surfactant is 0.1 times or more to less than 2.0 times of the critical micelle concentration of the surfactant.

The present invention can solve the conventional problems and achieves the object, and the present invention can provide a toner which is excellent in releasing ability upon low-temperature fixing, causes less filming, decreases the amount of volatile matter upon fixing, has both desired low-temperature fixing ability and desired heat resistant storage stability, and both desired low-temperature fixing ability and desired separation ability of paper from a roller upon high temperature fixing, a method for producing the toner, and a process cartridge, since a toner is formed using toner-forming materials at least contain a binder, a colorant, and a wax having a molecular chain consisting of C—H bond and C—C bond, wherein the total amount of the wax in the toner measured by a DSC method is 1% by mass to 8% by mass by, and a ratio (Sbet/SF) of a BET specific surface area (Sbet) of the toner to an average circularity (SF) of the toner is 1.0 m²/g or more to less than 3.6 m²/g.

### BRIEF DESCRIPTION OF THE DRAWINGS

FIG. 1 is a cross-section TEM picture showing an example of a toner of the present invention.

FIG. 2 is a schematic structural diagram showing an example of an image forming apparatus used in the present invention.

FIG. 3 is a schematic structural diagram showing an example of a tandem image forming unit.

FIG. 4 is a schematic structural diagram showing an example of a process cartridge used in the present invention.

FIG. 5 is a schematic structural diagram showing an example of a fixing unit of the image forming apparatus used in the present invention.

### DETAILED DESCRIPTION OF THE INVENTION

### Toner

The toner of the present invention contains a binder, a colorant, and a wax having a molecular chain consisting of C—H bond and C—C bond, wherein the mass reduction of the wax at 165° C. is 10% by mass or less, and the total amount of the wax in the toner measured by a DSC method is 1% by mass to 8% by mass, and wherein a ratio, Sbet/SF, of a BET specific surface area (Sbet) of the toner to an average circularity (SF) of the toner is 1.0 m²/g or more to less than 3.6 m²/g, wherein the toner is obtained through a process which contains at least emulsifying or dispersing a toner material liquid in an aqueous medium containing a surfactant, and wherein the toner material liquid is a liquid containing toner-forming materials which contain at least the binder, the colorant and the wax.

In the present invention, the particles which have been surface treated and are not subjected to external additive treatment may be considered as “toner base particles”, and the particles which are not surface treated may be called as “colorant particles”.

### <Toner Material Liquid>

The toner material liquid is formed of a liquid containing toner forming materials (also referred to as a toner material), and formed by dissolving and/or dispersing the toner-forming materials in an oil medium. The toner-forming materials contain at least a binder, a colorant and a wax, and further contains other components such as a charge control agent, as necessary.

### <Binder>

The binder component is not particularly limited and can be appropriately selected depending on the intended purpose. Examples thereof include a binder resin and a precursor of the binder resin.

The binder resin exhibits adhesiveness to a recording medium such as paper, preferably includes an adhesive polymer (reaction product) obtained by emulsifying or dispersing in the aqueous medium an active hydrogen group-containing compound and a polymer having reactivity with an active hydrogen group of the active hydrogen group-containing compound (a binder resin precursor). By containing these components, gel content can be easily added in a toner. Moreover, the binder resin may include a binder resin selected from known binder resins.

The mass average molecular mass of the binder resin is not particularly limited and can be appropriately selected depending on the intended purpose. It is preferably 3,000 to 45,000, more preferably 4,000 to 30,000, and particularly preferably 4,000 to 20,000.

When the mass average molecular mass is less than 3,000, the hot offset resistance may decrease.

In the case where a polyester resin is contained as the binder resin in the toner, the mass average molecular mass of the tetrahydrofuran (THF)-soluble polyester resin is not particularly limited and can be appropriately selected depending on the intended purpose. It is preferably 3,000 to 30,000.

The glass transition temperature of the binder resin is not particularly limited and can be appropriately selected depending on the intended purpose. It is preferably 35° C. to 65° C., and more preferably 45° C. to 65° C. When the glass transition temperature is less than 35° C., the heat resistant storage stability of the toner may be poor. When the glass transition temperature is more than 65° C., the low-temperature fixing ability may be inadequate. The toner containing a polyester resin, which has been subjected to elongation reaction or crosslinking reaction as the binder resin, has excellent storage stability even though the toner has a low glass transition temperature.

The binder resin is not particularly limited and can be appropriately selected depending on the intended purpose. It is preferably a polyester resin, and more preferably polyester which has not been modified (also referred to as an unmodified polyester resin).

The acid value of the unmodified polyester resin is not particularly limited and can be appropriately selected depending on the intended purpose. It is preferably 1.0 mgKOH/g to 50.0 mgKOH/g, more preferably 1.0 mgKOH/g to 30.0 mgKOH/g, even more preferably 12 mgKOH/g to 30 mgKOH/g, and particularly preferably 15 mgKOH/g to 25 mgKOH/g. By adjusting the acid value within these ranges, the resultant toner is likely to be negatively charged.

Moreover, in the present invention, in the case where the toner contains a compound containing an active hydrogen group (hereinafter also referred to as an active hydrogen group-containing compound), a polymer reactive with the active hydrogen group, and as the binder resin a reaction product obtained by reacting the compound containing an active hydrogen group and the polymer in a step of emulsifying or dispersing the toner material liquid in the aqueous medium, when the acid value of the unmodified polyester resin is less than 12 mgKOH/g, the reaction speed slows down, and the viscosity of the toner material liquid becomes high, causing difficulty in emulsifying or dispersing the toner material liquid in the aqueous medium, although this reason is not sure. When the acid value of the unmodified polyester resin is more than 30 mgKOH/g, hot offset resistance becomes poor. The toner preferably contains 50% by mass to 100% by mass of the polyester resin as the binder resin.

The resin precursor is not particularly limited and can be appropriately selected depending on the intended purpose; suitable examples thereof include modified polyester resins reactive with active hydrogen group-containing compounds. The modified polyester resins are not particularly limited and can be appropriately selected depending on the intended purpose; isocyanate group-containing polyesters are preferable as a polymer that is reactive with an active hydrogen group. Moreover, a urea bond may be formed by addition of an alcohol upon reaction of the isocyanate group-containing polyester resin with the active hydrogen group-containing compound. The molar ratio of an urethane bond to the thus obtained urea bond (for the purpose of distinguishing it from an urethane bond in the isocyanate group-containing polyester prepolymer) is not particularly limited and can be appropriately selected depending on the intended purpose. It is preferably 0 to 9, more preferably 1/4 to 4/1, and particularly preferably 2/3 to 7/3. When this molar ratio is greater than 9, the hot offset resistance may decrease.

The binder resin is not particularly limited and can be appropriately selected depending on the intended purpose. Specific examples thereof include the following compounds (I) to (10): (1) a mixture of polycondensation product of bisphenol A ethylene oxide (2 mol) adduct and isophthalic acid, and urea-modified polyester prepolymer which is obtained by reacting isophorone disocyanate with a polycondensation product of bisphenol A ethylene oxide (2 mol) adduct and isophtalic acid and modifying with isophorone diamine; (2) a mixture of a polycondensation product of bisphenol A ethylene oxide (2 mol) adduct and isophthalic acid, and urea-modified polyester prepolymer which is obtained by reacting isophorone disocyanate with a polycondensation product of bisphenol A ethylene oxide (2 mol) adduct and terephthalic acid, and modifying with isophorone diamine; (3) a mixture of polycondensation product of bisphenol A ethylene oxide (2 mol) adduct, bisphenol A propylene oxide (2 mol) adduct and terephthalic acid, and urea-modified polyester prepolymer which is obtained by reacting isophorone disocyanate with polycondensation product of bisphenol A ethylene oxide (2 mol) adduct, bisphenol A propylene oxide (2 mol) adduct and terephthalic acid, and modifying with isophorone diamine; (4) a mixture of polycondensation product of bisphenol A ethylene oxide (2 mol) adduct, bisphenol A propylene oxide (2 mol) adduct and terephthalic acid, and urea-modified polyester prepolymer which is obtained by reacting isophorone disocyanate with polycondensation product of bisphenol A propylene oxide (2 mol) adduct and terephthalic acid, and modifying with isophorone diamine; (5) a mixture of polycondensation product of bisphenol A ethylene oxide (2 mol) adduct and terephthalic acid, and urea-modified polyester prepolymer which is obtained by reacting isophorone disocyanate with polycondensation product of bisphenol A ethylene oxide (2 mol) adduct and terephthalic acid, and modifying with hexamethylene diamine; (6) a mixture of polycondensation product of bisphenol A ethylene oxide (2 mol) adduct and terephthalic acid, and urea-modified polyester prepolymer which is obtained by reacting isophorone disocyanate with polycondensation product of bisphenol A ethylene oxide (2 mol) adduct, a bisphenol A propylene oxide (2 mol) adduct and terephthalic acid, and modifying with hexamethylene diamine; (7) a mixture of polycondensation product of bisphenol A ethylene oxide (2 mol) adduct and terephthalic acid, and urea-modified polyester prepolymer which is obtained by reacting isophorone disocyanate with polycondensation product of bisphenol A ethylene oxide (2 mol) adduct and terephthalic acid, and modifying with ethylene diamine; (8) a mixture of polycondensation product of bisphenol A ethylene oxide (2 mol) adduct and isophthalic acid, and urea-modified polyester prepolymer which is obtained by reacting diphenylmethane disocyanate with polycondensation product of bisphenol A ethylene oxide (2 mol) adduct and isophthalic acid, and modifying with hexamethylene diamine; (9) a mixture of polycondensation product of bisphenol A ethylene oxide (2 mol) adduct, bisphenol A propylene oxide (2 mol) adduct, terephthalic acid and dodecenylsuccinic anhydride, and urea-modified polyester prepolymer which is obtained by reacting diphenylmethane disocyanate with polycondensation product of bisphenol A ethylene oxide (2 mol) adduct, bisphenol A propylene oxide (2 mol) adduct, terephthalic acid, and modifying with hexamethylene diamine; and (10) a mixture of polycondensation product of bisphenol A ethylene oxide (2 mol) adduct and isophthalic acid, and urea-modified polyester prepolymer which is obtained by reacting toluene disocyanate with polycondensation product of bisphenol A ethylene oxide (2 mol) adduct and isophthalic acid and modifying with hexamethylene diamine.

The active hydrogen group-containing compound functions as an elongation agent or crosslinking agent when a polymer reactive with an active hydrogen group undergoes an elongation or crosslinking reaction in an aqueous medium. The active hydrogen group is not particularly limited and can be appropriately selected depending on the intended purpose. Specific examples of the active hydrogen group include hydroxyl groups (e.g., an alcoholic hydroxyl group and phenolic hydroxyl group), amino groups, carboxyl groups, and mercapto groups. These may be used alone or in combination. The active hydrogen group-containing compound is not particularly limited and can be appropriately selected depending on the intended purpose. For example, in the case where the polymer reactive with an active hydrogen group is an isocyanate group-containing polyester prepolymer, amines are preferable since the molecular mass can be increased by the elongation reaction or crosslinking reaction with the polyester prepolymer.

The amines are not particularly limited and can be appropriately selected depending on the intended purpose; examples thereof include diamines, trivalent or higher polyamines, amino alcohols, amino mercaptans, amino acids, and the above amines in which amino groups are blocked. These amines can be used alone or in combination. Of these, diamines, and mixtures of diamines with a small amount of the polyamines are particularly preferable.

The diamines are not particularly limited and can be appropriately selected depending on the intended purpose. Examples thereof include aromatic diamines, alicyclic diamines and aliphatic diamines. The aromatic diamines are not particularly limited and can be appropriately selected depending on the intended purpose. Examples thereof include phenylene diamine, diethyltoluene diamine and 4,4′-diaminodiphenylmethane. The alicyclic diamines are not particularly limited and can be appropriately selected depending on the intended purpose. Examples thereof include 4,4′-diamino-3,3′-dimethyldicyclohexylmethane, diaminocyclohexane and isophorone diamine. The aliphatic diamines are not particularly limited and can be appropriately selected depending on the intended purpose. Examples thereof include ethylene diamine, tetramethylene diamine and hexamethylene diamine. The trivalent or higher polyamines are not particularly limited and can be appropriately selected depending on the intended purpose. Examples thereof include diethylene triamine and triethylene tetramine. The amino alcohols are not particularly limited and can be appropriately selected depending on the intended purpose. Examples thereof include ethanolamine and hydroxyethylaniline. The amino mercaptans are not particularly limited and can be appropriately selected depending on the intended purpose. Examples thereof include aminoethylmercaptan and aminopropylmercaptan. The amino acids are not particularly limited and can be appropriately selected depending on the intended purpose. Examples thereof include amino propionic acid and amino capric acid. The above amines with blocked amino groups are not particularly limited and can be appropriately selected depending on the intended purpose. Examples thereof include ketimine compounds and oxazoline compounds, which are obtained by blocking the amino groups of the above amines with a ketone such as acetone, methyl ethyl ketone or methyl butyl ketone.

A reaction terminator may be used to stop the elongation reaction, crosslinking reaction or the like between the active hydrogen group-containing compound and the polymer reactive with an active hydrogen group. The reaction terminator is preferably employed for adjusting the molecular mass, etc., of the adhesive base material to be within a preferable range. The reaction terminator is not particularly limited and can be appropriately selected depending on the intended purpose. Examples thereof include monoamines such as diethylamine, dibutylamine, butylamine and laurylamine, and also ketimine compounds obtained by blocking the amino groups of these monoamines. The ratio of the equivalent mass of isocyanate group of the polyester prepolymer to the equivalent mass of amino group of the amines is preferably from 1/3 to 3/1, more preferably from 1/2 to 2/1, and particularly preferably from 2/3 to 1.5/1. When this ratio is less than 1/3, the low-temperature fixing ability may decrease. When the ratio is more than 3/1, the molecular mass of the urea-modified polyester decreases, adversely affecting the hot offset resistance.

The polymer reactive with an active hydrogen group (hereinafter sometimes referred to as “prepolymer”) is not particularly limited and can be appropriately selected from known resins and the like. Examples thereof include polyol resins, polyacrylic resins, polyester resins, epoxy resins, and derivatives thereof. These resins may be used alone or in combination. Of these, polyester resins are especially preferable for their higher flowability and transparency when melted. The functional groups reactive with the active hydrogen group of the prepolymer are not particularly limited and can be appropriately selected depending on the intended purpose. Examples thereof include isocyanate group, epoxy group, carboxyl group, and a functional group having the formula —COC—, with isocyanate group being preferable. The prepolymer may contain one or more of these functional groups.

As the prepolymer, it is preferable to use a polyester resin having isocyanate group or the like, which can produce a urea bond, since the molecular weights of polymer components can be readily adjusted and oil-less low-temperature fixing ability can be ensured in dry toner, particularly since it is possible to ensure excellent releasing ability and fixing ability even when there is no mechanism for applying a releasing oil to the heat medium for toner fixation. The isocyanate group-containing polyester prepolymer is not particularly limited and can be appropriately selected depending on the intended purpose; specific examples thereof include reaction products of polyisocyanate and active hydrogen group-containing polyester resins obtained by polycondensation of polyols with polycarboxylic acids.

The polyols are not particularly limited and can be appropriately selected depending on the intended purpose; examples thereof include diols, trivalent or higher polyols, and mixtures of diols and trivalent or higher polyols. Of these, preferable are diols and mixtures of diols and a small amount of trivalent or higher polyols. These polyols may be used alone or in combination.

The diols are not particularly limited and can be appropriately selected depending on the intended purpose. Specific examples of the diols include alkylene glycols such as ethylene glycol, 1,2-propylene glycol, 1,3-propylene glycol, 1,4-butanediol, and 1,6-hexanediol; oxyalkylene group-containing diols such as diethylene glycol, triethylene glycol, dipropylene glycol, polyethylene glycol, polypropylene glycol, and polytetramethylene glycol; alicyclic diols such as 1,4-cyclohexane dimethanol and hydrogenated bisphenol A; alkylene oxide adducts of the alicyclic diols, such as those obtained by adding an alkylene oxide such as ethylene oxide, propylene oxide, butylene oxide or the like to the alicyclic diols; bisphenols such as bispheonol A, bisphenol F, and bisphenol S; and alkylene oxide adducts of bisphenols, such as those obtained by adding an alkylene oxide such as ethylene oxide, propylene oxide, or butylene oxide to the bisphenols. The number of carbon atoms of the alkylene glycols is not particularly limited but preferably 2 to 12. Of these, preferable are alkylene glycols having 2 to 12 carbon atoms and alkylene oxide adducts of bisphenols, with alkylene oxide adducts of bisphenols and mixtures of alkylene oxide adducts of bisphenols and alkylene glycols having 2 to 12 carbon atoms being particularly preferable.

The trivalent or higher polyols are not particularly limited and can be appropriately selected depending on the intended purpose. Examples thereof include trivalent or higher aliphatic alcohols, trivalent or higher polyphenols, or alkylene oxide adducts of trivalent or higher polyphenols are preferable. The trivalent or higher aliphatic alcohols are not particularly limited and can be appropriately selected depending on the intended purpose. Examples thereof include glycerine, trimethylol ethane, trimethylol propane, pentaerythritol, and sorbitol. The trivalent or higher polyphenols are not particularly limited and can be appropriately selected depending on the intended purpose. Examples thereof include trisphenol PA, phenol novolac, and cresol novolac. The alkylene oxide adducts of above-mentioned trivalent or higher polyphenols are not particularly limited and can be appropriately selected depending on the intended purpose. Specific examples thereof include those obtained by adding an alkylene oxide such as ethylene oxide, propylene oxide, or butylene oxide to trivalent or higher polyphenols. When the diol and trivalent or higher alcohol is to be mixed, the amount of trivalent or higher alcohol relative to the diol is not particularly limited and can be appropriately selected depending on the intended purpose. It is preferably 0.01% by mass to 10% by mass, more preferably 0.01% by mass to 1% by mass.

The polycarboxylic acids are not particularly limited and can be appropriately depending on the intended purpose; examples thereof include dicarboxylic acids, trivalent or higher carboxylic acids, and mixtures thereof, with dicarboxylic acids and the mixtures of dicarboxylic acids and a small amount of trivalent or higher carboxylic acids being preferable. These polycarboxylic acids may be used alone or in combination.

The dicarboxylic acids are not particularly limited and can be appropriately selected depending on the intended purpose. Examples thereof include dialkanoic acids, dialkenoic acids, and aromatic dicarboxylic acids. The dialkanoic acids are not particularly limited and can be appropriately selected depending on the intended purpose. Examples thereof include succinic acid, adipic acid, and sebacic acid. The number of carbon atoms of the dialkenoic acids are not particularly limited and can be appropriately selected depending on the intended purpose. It is preferably 4 to 20. The dialkenoic acids having 4 to 20 carbon atoms are not particularly limited and can be appropriately selected depending on the intended purpose. Examples thereof include maleic acid, and fumaric acid. The number of carbon atoms of the aromatic dicarboxylic acids is not particularly limited and can be appropriately selected depending on the intended purpose. It is preferably 8 to 20. The aromatic dicarboxylic acids having 8 to 20 carbon atoms are not particularly limited and can be appropriately selected depending on the intended purpose. Examples thereof include phthalic acid, isophthalic acid, terephthalic acid, and naphthalen dicarboxylic acid.

The trivalent or higher carboxylic acids are not particularly limited and can be appropriately selected depending on the intended purpose. For example, trivalent or higher aromatic carboxylic acids can be used. The number of carbon atoms of the trivalent or higher aromatic carboxylic acids are not particularly limited and can be appropriately selected depending on the intended purpose. It is preferably 9 to 20. The trivalent or higher aromatic carboxylic acids having 9 to 20 carbon atoms are not particularly limited and can be appropriately selected depending on the intended purpose. Examples thereof include trimellitic acid, and pyromellitic acid. The polycarboxylic acids are not particularly limited and can be appropriately selected depending on the intended purpose. Examples thereof include acid anhydrides or lower alkyl esters of any of dicarboxylic acids, trivalent or higher carboxylic acids, and mixtures thereof. The lower alkyl ester is not particularly limited and can be appropriately selected depending on the intended purpose. Examples thereof include methyl ester, ethyl ester, and isopropyl ester.

When the dicarboxylic acid and trivalent or higher carboxylic acid are mixed, the amount of the trivalent or higher carboxylic acid relative to the dicarboxylic acid is not particularly limited and can be appropriately selected depending on the intended purpose. It is preferably 0.01% by mass to 10% by mass, more preferably 0.01% by mass to 1% by mass. The ratio of the equivalent mass of hydroxyl group in the polyol to the equivalent mass of carboxyl group in the polycarboxylic acid upon polycondensation of the polyol with polycarboxylic acid is preferably 1 to 2, more preferably 1 to 1.5, and most preferably 1.02 to 1.3.

The amount of the polyol-derived component in the isocyanate group-containing polyester prepolymer is not particularly limited and can be appropriately selected depending on the intended purpose. It is preferably 0.5% by mass to 40% by mass, more preferably 1% by mass to 30% by mass and particularly preferably 2% by mass to 20% by mass. When the amount is less than 0.5% by mass, it may result in poor hot offset resistance, causing difficulty in ensuring heat resistant storage stability and low-temperature fixing ability at the same time. When the amount is greater than 40% by mass, it may result in reduced low-temperature fixing ability.

The above polyisocyanates are not particularly limited and can be appropriately selected depending on the intended purpose; examples thereof include aliphatic diisocyanates, alicyclic diisocyanates, aromatic diisocyanates, aromatic aliphatic diisocyanates, isocyanurates, and blocked products thereof obtained by blocking with phenol derivative, oxime, caprolactam, or the like.

The aliphatic diisocyanates are not particularly limited and can be appropriately selected depending on the intended purpose; examples thereof include tetramethylene diisocyanate, hexamethylene diisocyanate, 2,6-diisocyanate methyl caproate, octamethylene diisocyanate, decamethylene diisocianate, dodecamethylene diisocyanate, tetradecamethylene diisocyanate, trimethyl hexane diisocyanate, and tetramethyl hexane diisocyanate.

The alicyclic diisocyanates are not particularly limited and can be appropriately selected depending on the intended purpose; examples thereof include isophorone diisocyanate, and cyclohexylmethane diisocyanate.

The aromatic diisocyanates are not particularly limited and can be appropriately selected depending on the intended purpose; examples thereof include tolylene diisocyanate, diphenylmethane diisocyanate, 1,5-naphthylene diisocyanate, diphenylene-4,4′-diisocyanate, 4,4′-diisocyanato-3,3′-dimethyl diphenyl, 3-methyldiphenyl methane-4,4′-diisocyanate, and diphenylether-4,4′-diisocyanate.

The aromatic aliphatic diisocyanates are not particularly limited and can be appropriately selected depending on the intended purpose; examples thereof include α,α,α′,α′-tetramethyl xylylene diisocyanate. Examples of the isocyanurates include tris-isocyanatoalkyl-isocyanurate, and tris(isocyanatocycroalkyl)isocyanurate. These may be used alone or in combination.

Upon reaction of the polyisocyanate with a hydroxyl group-containing polyester resin, the ratio of the equivalent mass of isocyanate group in the polyisocyanate to the equivalent mass of hydroxyl group in the polyester resin are not particularly limited and can be appropriately selected depending on the intended purpose. It is preferably 1 to 5, more preferably 1.2 to 4, and particularly preferably 1.5 to 3. When the ratio is greater than 5, the low-temperature fixing ability may be poor. When the ratio is less than 1, offset resistance may be poor.

The amount of the polyisocyanate-derived component in the isocyanate group-containing polyester prepolymer is not particularly limited and can be appropriately selected depending on the intended purpose. It is preferably 0.5% by mass to 40% by mass, more preferably 1% by mass to 30% by mass, and particularly preferably 2% mass to 20% by mass. When the amount is less than 0.5% by mass, the hot offset resistance may be poor. When the amount is greater than 40% by mass, the low-temperature fixing ability may be poor.

The average number of isocyanate groups per one molecule of the polyester prepolymer is not particularly limited and can be appropriately selected depending on the intended purpose. It is preferably 1 or more, more preferably 1.2 to 5, and particularly preferably 1.5 to 4. When the average number is less than 1, the molecular mass of the urea-modified polyester resin decreases and thus the hot offset resistance may decrease.

The mass-average molecular mass of the polymer reactive with an active hydrogen group is not particularly limited and can be appropriately selected depending on the intended purpose. It is preferably 1,000 to 30,000, more preferably 1,500 to 15,000. When the mass-average molecular mass is less than 1,000, the heat resistant storage stability may be poor. When the mass-average molecular mass is greater than 30,000, the low-temperature fixing ability may be poor.

The mass average molecular mass can be found for instance by measuring tetrahydrofran (THF)-soluble matter using gel permeation chromatography (GPC) as follows. At first, a column is equilibrated in a heat chamber at 40° C. At this temperature tetrahydrofuran (THF), as a column solvent, is passed through the column at the flow rate of 1 mL/min. To this column, 50 μL to 200 μL of the tetrahydrofuran solution in which a sample concentration is adjusted to 0.05% by mass to 0.6% by mass were added. In this measurement, the molecular mass distribution is obtained from the relationship between the logarithm value of analysis curve prepared from several standard samples and counts. The standard samples for the analysis curve are, for example, monodispersed polystyrene samples respectively having a molecular mass of 6×10², 2.1×10³, 4×10³, 1.75×10⁴, 1.1×10⁵, 3.9×10⁵, 8.6×10⁵, 2×10⁶, and 4.48×10⁶ (available from Pressure Chemical Co. or Toyo Soda Co. Ltd.) It is preferable to use about 10 standard samples. Note that a refractive index detector can be used as a detector.

In the present invention any binder resin can be appropriately used depending on the intended purpose, and polyester resins and the like can be used; however, unmodified polyester resins are preferable. By using such unmodified polyester resins the low-temperature fixing ability and glossiness can be improved. Examples of the unmodified polyester resins include polycondensates of polyols and polycarboxylic acids. It is preferable that a part of the unmodified polyester resin be compatibilized with a urea-modified polyester resin, i.e., that the unmodified polyester resin and the urea-modified polyester resin have similar structures compatible with each other, for the purpose of improving the low-temperature fixing ability and hot offset resistance.

The mass-average molecular mass of the unmodified polyester resin are not particularly limited and can be appropriately selected depending on the intended purpose. It is preferably 1,000 to 30,000, more preferably 1,500 to 15,000. When the mass-average molecular mass is less than 1,000, the heat resistant storage stability may be poor. For this reason, it is preferable that the amount of components having a mass-average molecular mass of less than 1,000 be 8% by mass to 28% by mass. When the mass-average molecular mass is greater than 30,000, the low-temperature fixing ability may be poor.

The glass transition temperature of the unmodified polyester resin is not particularly limited and can be appropriately selected depending on the intended purpose. It is preferably 30° C. to 70° C., more preferably 35° C. to 60° C., and particularly preferably 35° C. to 55° C. When the glass transition temperature is less than 30° C., the heat resistant storage stability may be poor. When the glass transition temperature is greater than 70° C., the low-temperature fixing ability may be poor.

The hydroxyl value of the unmodified polyester resin is not particularly limited and can be appropriately selected depending on the intended purpose. It is preferably 5 mgKOH/g or more, more preferably 10 mgKOH/g to 120 mgKOH/g, and particularly preferably 20 mgKOH/g to 80 mgKOH/g. When the hydroxyl value is less than 5 mgKOH/g, it may become difficult to ensure excellent heat resistant storage stability and low-temperature fixing ability at the same time.

When the toner contains the unmodified polyester resin, the mass ratio of the isocyanate group-containing polyester prepolymer to the unmodified polyester resin is not particularly limited and can be appropriately selected depending on the intended purpose. It is preferably 5/95 to 25/75, more preferably 10/90 to 25/75. When the mass ratio is less than 5/95, the hot offset resistance may be poor. When the mass ratio is greater than 25/75, the low-temperature fixing ability and glossiness of an image may decrease.

### <Colorant>

The colorants are not particularly limited and can be appropriately selected from known dyes and pigments depending on the intended purpose; examples thereof include carbon blacks, nigrosine dyes, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, R, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fiser Red, parachloroorthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanine blue, phthalocyanine blue, fast sky blue, indanthrene blue (RS, BC), indigo, ultramarine blue, iron blue, anthraquinone blue, fast violet B, methylviolet lake, cobalt purple, manganese violet, dioxane violet, anthraquinone violet, chrome green, zinc green, chromium oxide, viridian green, emerald green, pigment green B, naphthol green B, green gold, acid green lake, malachite green lake, phthalocyanine green, anthraquinone green, titanium oxide, zinc flower, and lithopone. These may be used alone or in combination.

The amount of the colorant in the toner is not particularly limited and can be appropriately selected depending on the intended purpose; it is preferably 1% by mass to 15% by mass, and more preferably 3% by mass to 10% by mass.

When it is less than 1% by mass, coloring strength of the toner may decrease. When it is more than 15% by mass, dispersion failure of the pigment may occur in the toner, causing degradation of coloring strength or electric properties of the toner.

The colorants may be combined with resins to form master batches. The resins are not particularly limited and can be appropriately selected from known resins depending on the intended purpose; examples thereof include polyesters, polymers of styrene or substituted styrenes, styrene copolymers, polymethyl methacrylates, polybuthyl methacrylates, polyvinyl chlorides, polyvinyl acetates, polyethylenes, polypropylenes, epoxy resins, epoxy polyol resins, polyurethanes, polyamides, polyvinyl butyral, polyacrylic acid resins, rosin, modified rosins, terpene resins, aliphatic hydrocarbon resins, alicyclic hydrocarbon resins, aromatic petroleum resins, chlorinated paraffin, and paraffin wax. These may be used alone or in combination.

### <Wax>

The wax is not particularly limited and can be appropriately selected depending on the intended purpose. It is preferably a long-chain hydrocarbon having a melting point of 50° C. to 90° C. and forming a molecular chain consisting of C—H bond and C—C bond. The long-chain hydrocarbon wax is not particularly limited and can be appropriately selected depending on the intended purpose. Examples thereof include microcrystalline waxes, paraffin waxes, polyethylene waxes, polypropylene waxes, and SAZOLE wax. Of these, microcrystalline waxes are preferable in terms of small amount of volatile matter at the time of fixation and improvement of the low-temperature fixing ability.

The melt viscosity of the wax at 140° C. is not particularly limited and can be appropriately selected depending on the intended purpose. It is preferably 6 mPa·s to 15 mPa·s.

The melt viscosity of the wax is measured by the Brookfield method using a B-type viscometer. Specifically, a measurement sample is heated from ambient temperature until the measurement sample is melted. The value measured at 140° C. is preferably employed as the melt viscosity of the sample, since a temperature of 140° C. is close to the actual fixation temperature and higher than the temperature at which the measurement sample is melted.

Moreover, the mass reduction of the wax at 165° C. is not particularly limited and can be approximately selected depending on the intended purpose, as long as it is 10% by mass or less. It is preferably 3% by mass or less.

When the mass reduction of the wax at 165° C. is 10% by mass or less, the amount of volatile matter upon fixation can be suppressed to be small.

The mass reduction of the wax at 165° C. can be measured in the following manner using TA-60WS and DTG-60 (manufactured by Shimadzu Corporation) as a measurement device.

The measurement results are analyzed using a data analysis software TA-60 version 1.52 (manufactured by Shimadzu Corporation). The mass reduction at 165° C. is calculated by the following equation.

Mass reduction at 165° C.=(A−B)/A×100

in the equation, A denotes a mass of the wax at 165° C. at 0 minutes, and B denotes a mass of the wax which has been maintained at 165° C. for 60 minutes.

The melting point of the wax is not particularly limited and can be appropriately selected depending on the intended purpose. The wax having a low melting point is preferable in terms of improvement of low-temperature fixing ability. The melting point of the wax is preferably 50° C. to 90° C., more preferably 50° C. to 78° C., particularly preferably 60° C. to 78° C. When the melting point is lower than 50° C., it may adversely affect the heat resistant storage stability of the wax. When the melting point is higher than 90° C., cold offset easily occurs upon low-temperature fixing. Moreover, when the wax is dispersed in a liquid, the wax is once melted in the liquid and then cooled to thereby produce a dispersion. When the melting point of the wax is higher than 90° C., it is necessary to set the boiling point of the liquid, in which the wax is dispersed, at higher than 90° C. In the case where such solvent is used, the temperature of the solvent becomes higher than the glass transition temperature of the toner upon removal of the solvent. There is a possibility that the toner blocking may occur. The melting point of the wax is generally decreased by decreasing the molecular mass of the wax. However, when the molecular mass of the wax is simply decreased, the amount of volatile matter increases. Microcrystalline wax is preferable in terms of decrease in melting point of the wax, and in the amount of the volatile matter of the wax upon fixation.

Moreover, the wax satisfying the above-mentioned requirement may adversely affect to the separation properties between a roller and paper upon fixation on the paper. Thus, it is necessary to contain gel content to some extent in the toner. The gel content in the toner can improve separation ability between the roller and the paper upon fixation. The gel content in the toner can be measured as a content insoluble in tetrahydrofuran (THF). The THF-insoluble matter is not particularly limited and can be appropriately selected depending on the intended purpose. It is preferably 5% by mass to 25% by mass. When the THF-insoluble matter is 5% by mass or more, decrease in the separation properties upon fixation can be prevented. When it is 25% by mass of less, decrease in the low-temperature fixing ability can be prevented.

### <Other Components>

The toner of the present invention may further contain a wax dispersant, a charge control agent, resin particles, inorganic particles, a flow improver, a cleaning improver, a magnetic material, a metal soap, in addition to the above-mentioned components.

### —Wax Dispersant—

The toner of the present invention may contain the wax dispersant together with the binder resin, the colorant, and the releasing agent (wax). By incorporating the wax dispersant into the toner, the releasing agent can be sufficiently dispersed in the binder resin. Moreover, when the amount of the releasing agent and the amount of the wax dispersant are appropriately adjusted, the dispersion state of the releasing agent can be easily controlled. Furthermore, the toner of the present invention contains 50% by mass to 100% by mass of the polyester resin, but the polyester resin is hardly compatible with the wax used in the toner of the present invention. When the wax dispersant is not used, the wax may not be introduced to the toner, and may be discharged to the aqueous medium. Moreover, the wax is released and exists on the toner surface, or the amount of the wax on the toner surface increases, causing contamination of other members. From these standpoints of view, the wax dispersant is preferably used.

The wax dispersant is preferably a graft polymer having a structure in which a resin (E) as a side chain is grafted to a resin (D) as a main chain. The resin (D) is not particularly limited and can be selected from known releasing agents as long as the resins (E) can be grafted. As the resin (D), polyolefin resins, more preferably polyolefin resins molded by heat loss are used. The olefins for forming the polyolefin resin are not particularly limited and can be appropriately selected depending on the intended purpose. Examples thereof include ethylene, propylene, 1-butene, isobutylene, 1-hexene, 1-dodecene, and 1-octadecene. Examples of the polyolefin resins include a copolymer of an olefin with another monomer capable of copolymerizing with the olefin.

The olefin polymers are not particularly limited and can be appropriately selected depending on the intended purpose. Examples thereof include polyethylene, polypropylene, an ethylene/propylene copolymer, an ethylene/1-butene copolymer, and a propylene/1-hexene copolymer. The oxides of olefin polymers are not particularly limited and can be appropriately selected depending on the intended purpose. Examples thereof include oxides of the above-mentioned olefin polymers. The modified olefin polymers are not particularly limited and can be appropriately selected depending on the intended purpose. Examples thereof include maleic acid derivative adducts of the above-mentioned olefin polymers. Specific examples of the maleic acid derivative include, but are not limited to, maleic anhydride, monomethyl maleate, monobutyl maleate, and dimethyl maleate.

The copolymers of an olefin with another monomer capable of copolymerizing with the olefin are not particularly limited and can be appropriately selected depending on the intended purpose. Examples thereof include copolymers of an olefin with an unsaturated carboxylic acid or with an unsaturated alkyl ester. Specific examples of the unsaturated carboxylic acids include, but are not limited to, (meth)acrylic acid, itaconic acid, and maleic anhydride. Specific examples of the alkyl esters of the unsaturated carboxylic acid include, but are not limited to, alkyl esters of a (meth)acrylic acid having 1 to 18 carbon atoms, and alkyl esters of maleic acid having 1 to 18 carbon atoms.

In the present invention, the monomer does not need to have an olefin structure, as long as the resultant polymer has a polyolefin structure. Therefore, a polymethylene such as SASOL wax, for example, can be used as a monomer for preparing the polyolefin resin. The polyolefin resin is not particularly limited and can be appropriately selected depending on the intended purpose. Of these, olefin polymers, oxides of olefin polymers, and modified olefin polymers are preferable; polyethylene, polymethylene, polypropylene, and ethylene/propylene copolymers, oxidized polyethylene, oxidized polypropylene, and maleinated polypropylene are more preferable; and polyethylene and polypropylene are particularly preferable.

Monomers constituting the resin (E) are not particularly limited and can be appropriately selected depending on the intended purpose. Examples thereof include alkyl (1 to 5 carbon atoms) esters of unsaturated carboxylic acids, such as methyl(meth)acrylate, ethyl(meth)acrylate, butyl(meth)acrylate, 2-ethyl hexyl(meth)acrylate, and the like; and vinyl ester monomers, such as vinyl acetate and the like. Of these, alkyl(meth)acrylate is preferred, and alkyl(meth)acrylate (E1) having 1 to 5 carbon atoms in the alkyl chain is more preferred.

Aromatic vinyl monomers (E2) used in combination with the alkyl(meth)acrylate (E1) as monomers constituting the resins (E) are not particularly limited and can be appropriately selected depending on the intended purpose. Examples thereof include styrene monomers, such as styrene, α-methylstyrene, p-methylstyrene, m-methylstyrene, p-methoxystyrene, p-hydroxystyrene, p-acetoxystyrene, vinyl toluene, ethyl styrene, phenyl styrene, benzyl styrene, and the like. Of these, styrene is preferred.

In the toner of the present invention, the mass ratio (D)/(E) of the resin (D) as the main chain of the wax dispersant to the resin (E) as the side chain is preferably 1 to 50. When the mass ratio is greater than 50, the compatibility between the wax dispersant and the binder resin becomes poor. When the mass ratio is less than 1, the wax dispersant is not sufficiently dissolved in the added releasing agent, causing poor dispersion of the releasing agent. The amount of the wax dispersant relative to the toner is not particularly limited and can be appropriately selected depending on the intended purpose. It is preferably 0.01 parts by mass to 8 parts by mass, more preferably 0.5 parts by mass to 6 parts by mass, in terms of maintaining the proper amount of the releasing agent existing on the toner surface, particularly, improving the releasing ability between the toner and a fixing roller or belt, and exhibiting excellent effect on resistant to smear.

The amount of the wax dispersant relative to the wax is not particularly limited and can be appropriately selected depending on the intended purpose. It is preferably 10% by mass to 300% by mass.

The glass transition temperature of the wax dispersant is not particularly limited and can be appropriately selected depending on the intended purpose. It is preferably 55° C. to 80° C., and more preferably 55° C. to 70° C. When the glass transition temperature is higher than 80° C., the low-temperature fixing ability may be impaired. When the glass transition temperature is lower than 55° C., the hot offset resistance may be poor.

### —Volume-Average Particle Diameter of Wax Dispersion Particles—

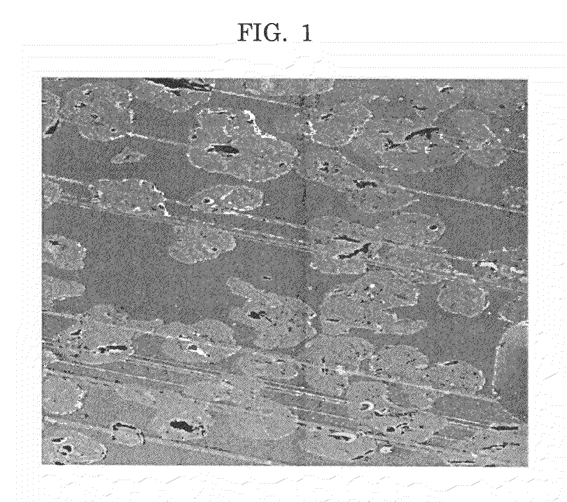

Whether or not at least a part of the wax is present in the toner particle as plural independent wax dispersion particles included in the toner particle and the dispersion condition of the wax in the toner particle are observed with a transmission electron microscope (TEM). Specifically, the observation of the toner particle is performed according to a method in which a sample of the toner particle is embedded in an epoxy resin, and sliced to a section having a thickness of about 100 μm, and the section is dyed with ruthenium tetraoxide, and then the cross section of the toner particle embedded in the epoxy resin is observed using the TEM at a magnification of 10,000. The TEM photograph of the cross section of the toner particle according to the present invention is shown in FIG. 1. As can be seen from this TEM photograph, the wax is not only dispersed in the near of the surface of the toner particle, but also dispersed uniformly inside the toner particle. By dispersing the wax in the toner particle under the above-noted dispersion condition, even when the amount of the wax contained in the toner particle is small, not only the hot-offset resistance of the toner can be effectively improved, but also the lowering of the charging ability, developing ability and blocking resistance of the toner can be prevented.

The wax dispersion particles are dispersed preferably uniformly in the toner particle. Here, “the wax particles are dispersed uniformly” means “a plurality of wax dispersion particles are dispersed in the toner particle without forming a large localization of the wax particles”. For example, it is also preferred that in a random cross section of the toner particle which includes the center of the toner particle, the number of the wax dispersion particles which are present within a concentric circle of the outer circle of the above-noted cross section of the toner particle, wherein the concentric circle has a radius which is 2/3 time the radius of the outer circle, is more than 30% and 60% or less, based on the number of the wax dispersion particles which are present in the whole surface of the above-noted cross section of the toner particle. The exposed area of the wax which exists on the outermost surface of the toner particle is preferably 5% or less, based on the area of the outermost surface of the toner particle.

The toner material liquid is formed by dispersing the wax in the oil medium. The volume average particle diameter of the wax dispersion particles in the toner material liquid is not particularly limited and can be appropriately selected depending on the intended purpose. It is preferably minute. For example, it is preferably 0.1 μm to 2 μm, and more preferably 0.1 μm 1 μm. When the average particle diameter of the wax dispersion particles is less than 0.1 μm, the releasing ability may not be sufficiently obtained. When the average particle diameter of the wax dispersion particles is more than 2 μm, uniformly dispersibility of the wax in the toner may be poor. The volume average particle diameter of the wax dispersion particles can be controlled by the amount of the wax dispersant and conditions of the wax dispersion. The dispersion diameter may be decreased by increasing the amount of the wax dispersant and adjusting the dispersion conditions.

A bead mill is preferably used for dispersion of the wax. The dispersion condition is adjusted by lengthening a dispersion time or speeding up the rotation number of the bead mill, or decreasing the diameter of the bead. The diameter of the bead of the bead mill is preferably 0.05 mm to 3 mm. When the diameter of the bead is larger than 3 mm, dispersion cannot be sufficiently performed. When the diameter of the bead is smaller than 0.05 mm, it becomes difficult to separate the beads from the wax by means of a separator of the bead mill, and it becomes hard to maintain dispersed state of the wax.

### —Charge Control Agent—

The charge control agent is not particularly limited and can be appropriately selected from those known in the art depending on the intended purpose; it is preferable to employ such a charge control agent that is close to either transparent or white as those made of colored materials change the color tone. Examples of the charge control agent include triphenylmethane dyes, molybdic acid chelate pigments, rhodamine dyes, alkoxy amines, quaternary ammonium salts such as fluorine-modified quaternary ammonium salts, alkylamides, phosphorous or compounds thereof, tungsten or compounds thereof, fluorine surfactants, metallic salts of salicylic acid, and metallic salts of salicylic acid derivatives. These may be used alone or in combination.

The charge control agent may be any of commercially available products; specific examples thereof include BONTRON P-51 (quaternary ammonium salt), BONTRON E-82 (oxynaphthoic acid metal complex), BONTRON E-84 (salicylic acid metal complex), and BONTRON E-89 (phenol condensate) available from Orient Chemical Industries, Ltd.; TP-302 and TP-415 (both quaternary ammonium salt molybdenum metal complex) available from Hodogaya Chemical Co., Copy Charge PSY VP2038 (quaternary ammonium salt), Copy Blue PR (triphenylmethane derivative), Copy Charge NEG VP2036 and Copy Charge NX VP434 (both quaternary ammonium salt) available from Hoechst Ltd.; LRA-901 and LR-147 (both boron metal complex) available from Japan Carlit Co., Ltd.; and quinacridone, azo pigment and other high-molecular mass compounds having a sulfonic group, a carboxyl group, quaternary ammonium salt, or the like.

The charge control agent may be dissolved and/or dispersed in the toner-forming materials after melting and kneading with a master batch, may be dissolved and/or dispersed into a solvent together with toner components, or may be immobilized to the surface of the resultant toner particles. The amount of the charge control agent in the toner depends on the type of a binder resin, presence or absence of additives, and a method of dispersing; however, it is preferably 0.1% by mass to 10% by mass, and more preferably 0.2% by mass to 5% by mass based on the amount of the binder resin. When amount of the charge control agent content is less than 0.1% by mass, charge control ability may not be obtained. When the amount is greater than 10% by mass, the charge amount of toner becomes so high that the electrostatic attraction force that attracts toner particles to the developing roller increases, causing decrease in developer flowability or image density.

### —Resin Particles—

The resin particles are not particularly limited as long as they are formed of resin capable of forming an aqueous dispersion liquid in an aqueous medium, and any resin can be selected from those known in the art. The resin particles may be formed of either thermoplastic resin or thermosetting resin. Specific examples thereof include vinyl resins, polyurethane resins, epoxy resins, polyester resins, polyamide resins, polyimide resins, silicone resins, phenol resins, melamine resins, urea resins, aniline resins, ionomer resins, and polycarbonate resins. Of these, the resin particles are preferably formed of at least one resin selected from the group consisting of vinyl resins, polyurethane resins, epoxy resins and polyester resins, because an aqueous dispersion liquid of fine, spherical resin particles can be readily prepared. These resins may be used alone or in combination.

The vinyl resins are not particularly limited as long as they are resins prepared by homopolymerization or copolymerization of a vinyl monomer. Specific examples of the vinyl resins include styrene-(meth)acrylate copolymers, styrene-butadiene copolymers, (meth)acrylate-acrylic acid ester copolymers, styrene-acrylonitrile copolymers, styrene-maleic anhydride copolymers, and styrene-(meth)acrylate copolymers.

The resin particles may be formed of a copolymer prepared by polymerization of a monomer containing a plurality of unsaturated groups. Such a monomer is not particularly limited and can be appropriately selected depending on the intended purpose; examples thereof include a sodium salt of sulfate ester of methacrylic acid ethylene oxide adduct, ELEMINOL RS-30 (available from Sanyo Chemical Industries, Ltd.), divinylbenzene, and 1,6-hexane-diol diacrylate.

The resin particles may be prepared by any known polymerization method, and are preferably prepared as an aqueous dispersion liquid of the resin particles. A method of preparation of the aqueous dispersion liquid of the resin particles is not particularly limited and can be appropriately selected depending on the intended purpose. Examples thereof include in the case of vinyl resins, a method of polymerizing a vinyl monomer by suspension-polymerization, emulsification polymerization, seed polymerization, or dispersion-polymerization; and in the case of polyaddition resins and condensation resins such as polyester resins, polyurethane resins and epoxy resins, a method in which a precursor (monomer, oligomer or the like) or solution containing the precursor is dispersed in an aqueous medium in the presence of a dispersant, and cured by heat or addition of a curing agent, a method in which a suitably selected emulsifier is dissolved in a precursor (monomer, oligomer or the like) or solution containing the precursor followed by addition of water to effect phase inversion emulsification, a method in which a resin is pulverized with a mechanical rotation-type, or jet-type pulverizer followed by classification to produce resin particles, and the resin particles are dispersed in water under the presence of a suitable dispersant, a method in which a resin solution is atomized to produce resin particles, and the resin particles are dispersed in water under the presence of a suitable dispersant, a method in which resin particles are deposited by addition of a poor solvent to resin solution or by cooling resin solution prepared by dissolving resin into a solvent by heating, the solvent is removed, and the resin particles is dispersed in water under the presence of a suitable dispersant, a method in which resin solution is dispersed in an aqueous medium under the presence of a suitable dispersant, followed by solvent removal by heating and reducing pressure, and a method in which a suitable emulsifier is dissolved into a resin solution, followed by phase inversion emulsification by addition of water.

### —Inorganic Particles—

The inorganic particles are not particularly limited and can be appropriately selected depending on the intended purpose. Examples thereof include particles made of silica, alumina, titanium oxide, barium titanate, magnesium titanate, calcium titanate, strontium titanate, iron oxide, copper oxide, zinc oxide, tin oxide, quartz sand, clay, mica, silicic pyroclastic rock, diatomaceous earth, chromic oxide, cerium oxide, iron oxide red, antimony trioxide, magnesium oxide, zirconium oxide, barium sulfate, barium carbonate, calcium carbonate, silicon carbide, or silicon nitride. These may be used alone or in combination. The primary particle diameter of the inorganic particles is not particularly limited and can be appropriately selected depending on the intended purpose. It is preferably 5 nm to 2 μm, more preferably 5 nm to 500 nm. The specific surface area of the inorganic particles, as measured by BET method, is not particularly limited and can be appropriately selected depending on the intended purpose. It is preferably 20 m²/g to 500 m²/g. The amount of the inorganic particle in the toner is not particularly limited and can be appropriately selected depending on the intended purpose. It is preferably 0.01% by mass to 5.0% by mass.

Surface treatment using the flow improver improves the hydrophobic properties of the toner surface, thereby preventing decrease in flow characteristics and charge characteristics under high-humidity conditions. The flow improver is not particularly limited and can be appropriately selected depending on the intended purpose. Specific examples thereof include silane coupling agents, silylating agents, fluorinated alkyl group-containing silane coupling agents, organic titanate-based coupling agents, aluminum-based coupling agents, silicone oils, and modified-silicone oils.

When the cleaning improver is added in the toner, removal of the developer remained on a photoconductor or a primary transfer medium after transfer is facilitated. The cleaning improver is not particularly limited and can be appropriately selected depending on the intended purpose. Specific examples thereof include stearic acid, fatty acid metal salts such as zinc stearate and calcium stearate, and resin particles obtained by soap-free emulsion polymerization, such as methyl polymethacrylate particles and polystyrene particles. The resin particles preferably have a narrow particle size distribution and preferably have a volume-average particle diameter of 0.01 μm to 1 μm.

The magnetic material is not particularly limited and can be appropriately selected from those known in the art depending on the intended purpose; examples thereof include iron powder, magnetite, and ferrite, with white magnetic materials being preferable in view of color tone.

### (Toner Physical Properties)

The ratio (Sbet/SF) of BET specific surface area of the toner (Sbet) to the average circularity (SF) of the toner is not particularly limited and can be appropriately selected depending on the intended purpose, as long as it is 1.0 m²/g or more to less than 3.6 m²/g. It is preferably 1.2 m²/g or more to less than 3.1 m²/g.

In the present invention, the toner surface is smoothed so as to improve quality. It is found that the smoothing of the detail of toner is represented by the BET specific surface area, and the smoothing of the whole toner particle is represented by the circularity, and that the ratio (Sbet/SF) of the measured values is adjusted to the above-mentioned range so as to achieve a desired quality.

### <BET Specific Surface Area>

The BET specific surface area (Sbet) of the toner is not particularly limited and can be appropriately selected depending on the intended purpose.

The BET specific surface area of the toner particles is measured with an automatic surface area and porosimetry analyzer (TriStar 3000: manufactured by Shimadzu Corporation). Specifically, about 0.5 g of a sample is weighed in a sample cell, and it is vacuum dried using a pretreatment system smartprep (manufactured by Shimadzu Corporation) for 24 hours, and then impurities and water on the sample surface are removed. The pretreated sample is set in TriStar 3000 to obtain the relation between nitrogen gas adsorption and relative pressure. Based on this relation, the BET specific surface area of the sample can be obtained by a multipoint BET method.

### <Average Circularity>

The average circularity (SF) of the toner is not particularly limited and can be appropriately selected depending on the intended purpose. It is preferably 0.940 or more to less than 0.975. When the average circularity (SF) is less than 0.940, many relatively large irregularities of approximately several hundreds nanometers are present on the toner surface. Thus, even though minute irregularities of several nanometers to several hundreds nanometers are smoothed in the present invention, high transfer efficiency may not be obtained. When the average circularity (SF) is 0.975 or more, the shape of the toner particle become close to true sphere. The cleaning ability of the remaining toner on a photoconductor or an intermediate transfer medium may be poor.

The average circularity can also be measured using a flow-type particle image analyzer FPIA-2000 (produced by Sysmex Corporation) by the following method. Specifically, 0.1 mL to 0.5 mL of a surfactant (preferably alkylbenzene sulfonate) is added as a dispersant into 100 mL to 150 mL of water in a container, from which solid impurities have previously been removed. Then, approximately 0.1 g to approximately 0.5 g of a measurement sample is added. The suspension in which a sample is dispersed is subjected to dispersing treatment by an ultrasonic dispersing device for approximately 1 minute to approximately 3 minutes, and the concentration of the dispersed solution is adjusted such that the number of particles of the sample is 3,000 per microliter to 10,000 per microliter. Under this condition, the particle shape and dispersion of the toner are measured using the analyzer.

### <Total Amount of Wax>

The total amount of wax contained in the toner particles, which is indicative of the dispersion state of the wax, can be determined by a differential scanning calorimeter (DSC) method. Specifically, a toner sample and a sample of wax sole are respectively measured using the following measurement device under the following conditions so as to obtain endothermic values of the waxes. The total amount of the wax contained in the toner particles is obtained based on the ratio between the resultant endothermic values of the waxes contained in the samples.

Measurement device: DSC device (DSC60, manufactured by Shimadzu Corporation)

Sample amount: about 5 mg

Temperature rising speed: 10° C./min

Measurement range: room temperature to 150° C.

Measurement environment: in nitrogen gas atmosphere

The total amount of the wax is calculated by the following Equation (1).

The total amount of wax (% by mass)=(Endotherm (J/g) of wax of a toner sample)×100/(Endotherm (J/g) of a wax single substance) Equation (1)

By means of the above-described measurement, when the wax is flown during the toner production process and the prearranged amount of the wax is not contained in the toner, it is possible to determine the total amount of the wax contained in the toner particle.

### <Tetrahydrofuran (THF)-Insoluble Matter>

The amount of tetrahydrofuran-insoluble matter in the toner is not particularly limited and can be appropriately selected depending on the intended purpose. It is preferably 5% by mass to 25% by mass. When the amount of the tetrahydrofuran-insoluble matter is less than 5% by mass, the molecular mass of the resin in the toner is too small, the maximum fixing temperature may be disadvantageously lowered. When the tetrahydrofuran-insoluble matter is more than 25% by mass, the molecular mass of the resin in the toner is too large, the minimum fixing temperature may increase, and the range of fixing temperature is narrowed. The tetrahydrofuran-insoluble matter can be identified by the following method.

(1) Approximately 1.0 g (A) of toner is weighed.

(2) To the toner approximately 50 g of THF is added, and left to stand at 20° C. for 24 hours.

(3) The resultant mixture is centrifuged, and filtrate using a quantitative filter paper.

(4) A solvent of the filtrate is vacuum dried, and the residue amount (B) of a resin is measured. The residue amount (B) is THF-soluble matter.

The THF-insoluble matter is obtained by the following Equation (2).

THF-insoluble matter (%)=[(A−B)/A]×100 Equation (2)

### <Volume-Average Particle Diameter>

The volume-average particle diameter of the toner is not particularly limited and can be appropriately selected depending on the intended purpose. It is preferably 1 μm to 8 μm, more preferably 2 μm to 8 μm, particularly preferably 4 μm to 7 μm. When the volume-average particle diameter is less than 1 μm, in the case of a two-component developer, toner fusion to a carrier surface occurs during long term stirring in the developing unit, which may reduce the charging ability of the carrier, and in the case of a one-component developer, toner filming to the development roller or toner fusing to members (e.g., a blade to form a thin toner film) occurs. When the volume-average particle diameter is greater than 8 μm, it becomes difficult to provide a high-resolution, high-quality image, and variations in toner particle diameter may increase after developer consumption or developer supply. Moreover, when the volume-average particle diameter is less than 1 μm, toner dust may easily occur in a primary transfer and a secondary transfer. On the other hand, when the volume-average particle diameter is greater than 8 μm, dod reproducibility may not be sufficiently performed, graininess in a half tone portion may be poor, failing to obtain a high definition image.

### <Ratio (Dv/Dn) of the Volume-Average Particle Diameter (Dv) to the Number-Average Particle Diameter (Dn)>

The ratio (Dv/Dn) of the volume-average particle diameter (Dv) to the number-average particle diameter (Dn) of the toner of the present invention is not particularly limited and can be appropriately selected depending on the intended purpose. It is preferably 1.00 to 1.25, more preferably 1.05 to 1.25. When this ratio falls within this range in the case of the two-component developer, variations in toner particle diameter are small in the developer even after toner consumption and toner supply have been repeated for a long time, and in addition, even after a long time stirring in the development device, excellent developing ability can be ensured. Moreover, when this requirement is met in the case of the one-component developer, variations in toner particle diameter decrease even after toner consumption or toner supply, and toner filming to a developing roller and toner fusing to members (e.g., a blade to form a thin toner film) are prevented, and in addition, even after long-time use of the developing device (i.e., long-time stirring of developer), excellent developing ability can be ensured. Thus, a high-quality image can be obtained. When the above ratio is greater than 1.25, it becomes difficult to provide a high-resolution, high-quality image, and variations in toner particle diameter may increase after toner consumption or toner supply.

The volume-average particle diameter, and the ratio of the volume-average particle diameter to the number-average particle diameter of the toner of the present invention can be determined as follows with a particle size analyzer Multisizer III, manufactured by Beckman Coulter, Inc. At first, 0.1 mL to 5 mL of surfactant (e.g., alkylbenzene sulfonate) as a dispersant is added to 100 mL to 150 mL of an aqueous electrolyte solution (e.g., approximately 1% by mass aqueous sodium chloride solution). Subsequently, about 2 mg to about 20 mg of a sample is added to the aqueous electrolyte solution. The aqueous electrolyte solution with suspended sample is then dispersed for about 1 minute to about 3 minutes with an ultrasonic disperser, and the volumes and numbers of toner particles are measured using a 100 μm-aperture to obtain a volume distribution and a number distribution. From these distributions, the volume-average particle diameter and number-average particle diameter of the toner can be found.

### <Penetration>

The penetration of the toner is not particularly limited and can be appropriately selected depending on the intended purpose. It is preferably 15 mm or more, more preferably 20 mm to 30 mm. When the penetration is less than 15 mm, heat resistant storage stability may be poor. The penetration can be measured with a penetration test in accordance with JIS K2235-1991. More specifically, a 50-mL glass container is filled with the toner and placed in a constant-temperature bath at 50° C. for 20 hours, and the toner is cooled to room temperature for penetration test. Note that greater values of penetration indicate better heat resistant storage stability.

### <Minimum Fixing Temperature and Offset-Free Temperature>

The toner of the present invention preferably has a low minimum fixing temperature and a high offset-free temperature for the purpose of ensuring low-temperature fixing ability and offset resistance. To achieve this it is preferable that the minimum fixing temperature be less than 140° C. and that the offset-free temperature be 200° C. or more. As used herein, “minimum fixing temperature” means a lower limit of the fixing temperature at which 70% or more of image density remains after scrubbing the obtained image. As used herein, “offset-free temperature” can be found by measuring a temperature where no offset occurs when an image is fixed using an image forming apparatus adjusted such that development is effected using a given amount of toner.

### <Softening Temperature>

Thermal characteristics of the toner are also referred to as flow tester characteristics and evaluated in terms of softening point, flow start temperature, and softening point as measured by ½ method. These parameters can be measured by an appropriately selected method; for example, an elevation-type flow tester, Flow Tester CFT500, manufactured by Shimadzu Corporation can be employed.

The softening point of the toner is preferably 30° C. or more, more preferably 50° C. to 90° C. When the softening point is less than 30° C., the heat resistant storage stability may decrease.

### <Flow Start Temperature>

The flow start temperature of the toner of the present invention is preferably 60° C. or more, more preferably 80° C. to 120° C. When the flow start temperature is less than 60° C., at least one of heat resistant storage stability and offset resistance may decrease.

<Softening Point by ½ Method>

The softening point of the toner of the present invention, as measured by ½ method, is preferably 90° C. or more, more preferably 100° C. to 170° C. When the softening point as measured by ½ method is less than 90° C., the offset resistance may be poor.

### <Glass Transition Temperature>

The glass transition temperature of the toner of the present invention is preferably 40° C. to 70° C., more preferably 45° C. to 65° C. When the glass transition temperature is 40° C. or more, the heat resistant storage stability of the toner is excellent and never decrease. When the glass transition temperature is more than 70° C., the low-temperature fixing ability may not be sufficient. The glass transition temperature can be measured for instance with a differential scanning calorimeter, DSC-60, manufactured by Shimadzu Corporation.

### <Image Density>

The image density of an image formed using the toner of the present invention is preferably 1.40 or more, more preferably 1.45 or more, and particularly preferably 1.50 or more. When the image density is less than 1.40, the image density is so low that it may fail to obtain high image quality. The image density can be found in the following manner. Using a tandem-type color image forming apparatus (IMAGIO NEO 450, manufactured by Ricoh Company, Ltd.), a solid image with a developer deposition amount of 0.35 mg/cm²±0.02 mg/cm² is printed onto copy paper (type 6200, manufactured by Ricoh Company, Ltd.) as a recording medium while adjusting the surface temperature of the fixing roller to 160° C.±2° C. Thereafter, the image densities of any given five points of the solid image are measured with X-Rite 938 Spectrodensitometer manufactured by X-Rite and averaged. In this way the average value is taken as the image density.

The color of the toner of the present invention is not particularly limited and can be appropriately selected depending on the intended purpose. For example, one or more selected from the group consisting of a black toner, cyan toner, magenta toner and yellow toner. The toner of each color can be obtained by properly selecting a colorant.

The toner material liquid can be prepared by dissolving and/or dispersing in an oil medium the toner-forming materials containing the active hydrogen group-containing compound, the polymer reactive with the active hydrogen group-containing compound, the wax, the colorant, and the charge control agent, etc. Among the toner-forming materials, the components other than the polymer reactive with the active hydrogen group-containing compound (prepolymer) may be added and mixed in the aqueous medium in preparation of the aqueous medium described below, or may be added together with the toner material liquid in the aqueous medium.

The oil medium is not particularly limited and can be appropriately selected depending on the intended purpose, as long as it is a solvent capable of dissolving and/or dispersing the toner material. The solvent preferably includes an organic solvent. Moreover, the organic solvent is preferably removed, when the toner base particles are formed or after the toner base particles have been formed. Volatile organic solvent with boiling points of less than 150° C. is preferable because it can be readily removed. When it is more than 150° C., toner particles may aggregate upon removal of the solvent. The organic solvent is not particularly limited and can be appropriately selected depending on the intended purpose; examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methylacetate, ethylacetate, methyl ethyl ketone, and methyl isobutyl ketone. Of these, toluene, xylene, benzene, methylene chloride, 1,2-dichloroethane, chloroform, carbon tetrachloride and the like are preferable, with ethyl acetate being particularly preferable. These may be used alone or in combination. The amount of the organic solvent is not particularly limited and can be appropriately determined depending the intended purpose; however it is preferably added in an amount of 40 parts by mass to 300 parts by mass, more preferably 60 parts by mass to 140 parts by mass, and particularly preferably 80 parts by mass to 120 parts by mass, relative to 100 parts by mass of the toner material.

### (Method for Producing Toner)

A method for producing the toner of the present invention includes emulsifying or dispersing the toner material liquid in the aqueous medium containing the surfactant, and thereafter, heating the toner material liquid so as to treat a surface of a toner particle (a surface treatment step). In the surface treatment step, the temperature of the toner dispersion liquid (T1) is 40° C. to 95° C., so that the toner can be easily produced. In this case, the temperature of the toner dispersion liquid (T1) is not particularly limited and can be appropriately selected depending on the intended purpose as long as it is 40° C. to 95° C. It is preferably 45° C. to 80° C. The surface treatment is preferably performed while the temperature of the toner dispersion liquid (T1) is held for 1 minute to 1 hour.

The inventors of the present invention have previously proposed various toner production technologies in which an organic solvent containing toner materials such as a crosslinkable low-molecular-mass binder resin component and a colorant is emulsified/dispersed in an aqueous dispersion liquid in the form of droplets, and the solvent is removed from the resultant O/W dispersion liquid to obtain toner base particles. Many of these technologies use aqueous dispersion liquids in which fine inorganic particles and/or resin particles are dispersed. Moreover, some technologies are toner production methods including a maturing step of toner base particles (surface treatment step), a step of washing the toner base particles so as to remove a surfactant derived from the O/W emulsion/dispersion liquid, and a step of treating the toner base particles with a surfactant. The inventors of the present invention deeply studied the toner production technology, and have found that when the maturing step is performed with a smaller amount of the surfactant, minute irregularities in the toner surface are regulated so as to obtain excellent surface smoothness. The inventors of the present invention have also found that this technique can be applied to other chemical toner production technologies as well as toner production using a pulverized toner. The inventors of the present invention conducted further studies based on the findings, and have achieved the method for producing a toner of the present invention.

The toner obtained by the above-described production method is preferably heated at a temperature close to a glass transition temperature of the toner in water in which a small amount of the surfactant is present. Thus, the binder resin component contained in colorant particles for toner is slightly softened, and flows in an extremely small area so as to make the surface area small. Therefore, minute irregularities of several nanometers to several hundreds nanometers present in a surface of the toner base particle can be smoothed. However, when the toner is simply heated without other treatments, the components other than the toner, particularly carrier may be severely contaminated. The reason for this is not sure, but it is estimated that, when the toner resin component is slightly softened as a result of heating, the low-molecular-mass component of the resin is exposed to the toner surface. When application of shearing force is performed in addition to heating, contamination of the components other than the toner can be reduced. Moreover, application of shearing force during heating prevents the toner from aggregation which would be otherwise caused by heating. It is preferred that the application of shearing force during heating be continuously performed in terms of productivity. For example, PIPELINE MIXER (available from PRIMIX Corporation) and EBARA MILDER (available from Ebara Corporation) are preferably used.

Generally, when the toner in a developing unit receives mechanical stress caused by, for example, stirring, an external additive attaches to the minute irregularities in the toner particle surface. As a result, a non-electrostatic adhesion force increases, and transfer efficiency decreases. In particular, when a toner having a small particle diameter is used, the non-electrostatic adhesion force between the toner particles and an electrophotographic photoconductor, or between the toner particles and an intermediate transfer medium increases, and the transfer efficiency further decreases. Moreover, it is known that transfer efficiency outstandingly decreases in a secondary transfer, since when the toner having a small particle diameter is used in a high speed device, the non-electrostatic adhesion force between the toner particles and the intermediate transfer medium increases due to decrease in size of the toner particles, and the time for the toner particles receiving a transfer electric field is shortened in a transfer nip portion, particularly, secondary transfer nip portion.

A heating method is preferably performed in such a manner that colorant particles dispersed in water is filtered to obtain a filter cake, and that the filter cake is adjusted to contain 50% by mass to 85% by mass of water, and then put in an ion-exchanged water adjusted at 50° C. to 98° C. Owing to this method, the colorant particles can be adjusted to a desired temperature, minute irregularities of the colorant particles can be removed for a short time, and the wax contained in the colorant particles can prevent from exposing.

Since the minute irregularities in the surface of the toner particles obtained by the method for producing a toner of the present invention is smoothed in the surface treatment step in some degree, it is possible to prevent the decrease in function caused by adhesion of the external additive to the irregularities in the surface of the toner particles. Even when the toner receives mechanical stress, the increase in the non-electrostatic adhesion force can be suppressed, thereby obtaining high transfer efficiency. By smoothing the minute irregularities of the toner surface, the toner surface area per unit mass of the surface-treated toner is smaller than that of the toner having such minute irregularities, increasing the effective coverage of the toner surface with a certain amount of the external additive. Thus, the effect of the external additive on a decrease of the non-electrostatic adhesion force increases, consequently, even when the toner is affected by the mechanical stress, increase in the non-electrostatic adhesion force can be suppressed, thereby obtaining high transfer efficiency.

In the present invention, the heating treatment is performed in water. When the heating treatment is performed in a gaseous phase, the toner particles are fused together easier than in water even at the same temperature, adversely affecting toner particle size distribution. Moreover, in the case where the heating treatment is performed in the gaseous phase, it is necessary to heat at high temperature, compared to the temperature required in water, accelerating fusion of toner particles. Thus, the heating treatment is preferably performed in water for surface treatment. In this case, when the concentration of the surfactant added in water is higher than twice of the critical micelle concentration, the surfactant disadvantageously protects the minute irregularities in the toner surface upon heating. Thus, the toner surface is not smoothed, and high transfer efficiency cannot be obtained. On the other hand, when the surfactant concentration is less than 0.1 times of the critical micelle concentration, not only the irregularities of several nanometers to several hundred nanometers, but also irregularities of several micrometers in the toner surface are smoothed, adversely affecting blade cleanability. Moreover, when the surfactant concentration is less than 0.1 times of the critical micelle concentration, toner particles tend to be fused by heating in the surface treatment step, and the toner particle size distribution may be poor.

Namely, the surfactant used in the surface treatment step of the present invention preferably has a concentration of 0.1 times or more to less than 2.0 times of the critical micelle concentration of the surfactant.

When the temperature of the toner dispersion liquid (T1) in the surface treatment step is lower than 45° C., the binder resin in the toner is not softened, and the toner surface is not smoothed, failing in obtaining high transfer efficiency. When the temperature of the toner dispersion liquid (T1) is higher than 90° C., in the case of using the surfactant having a low concentration used in the present invention, the toner resin is softened, and toner particles are fusion bonded, causing poor toner particle size distribution.

The toner of the present invention is obtained by adjusting the toner material containing at least the binder resin, the wax, and the colorant, in the aqueous medium containing the surfactant, and then further the surfactant is preferably removed from the toner. When the toner is obtained in the aqueous medium, the toner material is hydrophilic to water serving as a dispersion solvent, and the toner surface is easily smoothed by heating. Since in the production process, the method for producing the toner includes a state in which the toner is dispersed in the aqueous medium, and the step of removing the surfactant, it is possible to prevent increase of the number of steps associated with the surface treatment step in the production process.

The binder resin used in the present invention preferably contains a polyester resin. When the polyester resin is adjusted to have a low softening point to improve low-temperature fixing ability of the toner, the polyester resin is superior in impact resistance to other resins, thereby improving the stress resistance of the toner. Moreover, the polyester resin has a hydrophilic group in a molecular structure and has relatively high polarity, so as to have excellent hydrophilicity to the aqueous medium. Therefore, the polyester resin can easily achieve surface smoothness of the toner.

In the surface treatment step, bleeding of the wax from the toner may occur. When the wax bleeds out from the toner, the wax contaminates the components other than the toner, causing various problems. For example, in a developer obtained by mixing a toner and a carrier, a wax contaminates the carrier while printing over time, causing decrease in charge ability of the developer. Moreover, the wax contaminates a photoconductor, an abnormal printing image is formed. Thus, when the surface is smoothed, it is important to prevent the bleeding of the wax from the toner. Therefore, in the surface treatment step, the time for holding the temperature of the toner dispersion liquid (T1) is preferably 1 minute to 1 hour, and more preferably 3 minutes to 50 minutes. When the time is shorter than 1 minute, the ratio Sbet/SF of the BET specific surface area (Sbet) of the toner to the average circularity (SF) of the toner may easily become less than 1.0 m²/g. When the time is longer than 1 hour, the components other than the toner may be contaminated by bleeding of the wax.

### <Critical Micelle Concentration>

The critical micelle concentration of the surfactant in an aqueous medium is measured by a surface tension method, an electric conductivity method, a dye method or the like. For example, measurement is performed using a surface tensiometer Sigma (KSV Instruments Ltd.), and analysis is performed with an analysis program in the Sigma system. The surfactant is added dropwise to an aqueous medium in increments of 0.01% by mass, stirred and left to stand, and thereafter a surface tension is measured. From the resultant surface tension curve, the surfactant concentration at which the surface tension does not decrease through dropwise addition of the surfactant is obtained and regarded as the critical micelle concentration.

### <Shear Force Application>

A shear force application device is not particularly limited and can be appropriately selected depending on the intended purpose. A high speed shearing and mixing device is preferably used. The high speed shearing and mixing device is not particularly limited and can be appropriately selected depending on the intended purpose. Examples thereof include HOMOGENIZER POLYTRON (available from Central Scientific Commerce Inc.), HOMOGENIZER-HYSTRON (available from Nichion Medical and Scientific Instruments Co., Ltd.), BIOMIXER (available from Nippon Seiki Seisakusho Co., Ltd.), TURBO TYPE AGITATOR (available from Kodaira Seisakusho Co., Ltd.), ULTRADISPER (available from Asada Tekko Co., Ltd.), EBARA MILDER (available from Ebara Corporation), TK HOMO MIXER, TK LABODISPER, TK PIPELINE MIXER, TK HOMOMIC LINE MILL, TK HOMOJETTER, TK UNIMIXER, TK HOMOMIC LINE FLOW and TK AGI HOMO MIXER (available from PRIMIX Corporation). These may be used alone or in combination.

### <Measurement of Surfactant Concentration>

The surfactant concentration in the toner dispersion liquid is measured by the following method. The surfactant used in the toner dispersion liquid is added dropwise in an aqueous medium in increments of 0.01% by mass, and the conductivity of the surfactant is measured during addition to the aqueous medium, to hereby obtain a calibration curve of the surfactant. The conductivity of the toner dispersion liquid is measured, and the surfactant concentration in the toner dispersion liquid can be calculated based on the calibration curve of the surfactant.

A method for producing the toner includes emulsifying or dispersing the oil phase (the toner material liquid), which contains at least the binder resin, the colorant, and the wax, in the aqueous medium containing the surfactant, and granulating. As the toner production method by polymerization, a method of producing toner base particles while producing an adhesive base material is described below. In this method, preparation of an aqueous medium phase, preparation of a toner material-containing liquid, emulsification or dispersing of a toner material, production of an adhesive base material, solvent removal, synthesis of a polymer reactive with an active hydrogen group, synthesis of an active hydrogen group-containing compound, etc., are carried out.

Preparation of the aqueous medium phase (which is added as necessary) can be achieved by dispersing resin particles into an aqueous medium. The amount of the resin particles to be added in the aqueous medium is not particularly limited and can be appropriately selected depending on the intended purpose. It is preferably 0.5% by mass to 10% by mass.

The toner-forming material (toner material)-containing liquid can be prepared by dissolving or dispersing in a solvent a toner material containing an active hydrogen group-containing compound, a polymer reactive with an active hydrogen group, a pigment (colorant), a releasing agent (wax), and if necessary, a charge control agent, and an unmodified polyester resin, etc.

In the toner materials except for the polymer reactive with an active hydrogen group may be added in the aqueous medium upon dispersing of resin particles in the aqueous medium, or may be added in an aqueous medium upon addition of the toner material liquid in the aqueous medium. The toner material liquid preferably contains the binder, colorant and wax.

Emulsification or dispersing of the toner material can be achieved by dispersing of the toner material liquid in the aqueous medium. By allowing the active hydrogen group-containing compound and the polymer reactive with an active hydrogen group to undergo elongation reaction and/or crosslinking reaction upon emulsification or dispersing of the toner material, an adhesive base material is produced.

The adhesive base material (e.g., urea-modified polyester resin) may be produced by emulsifying or dispersing in an aqueous medium a liquid containing the polymer reactive with the active hydrogen group (e.g., isocyanate group-containing polyester prepolymer) together with an active hydrogen group-containing compound (e.g., amine) so that they undergo elongation reaction and/or crosslinking reaction in the aqueous medium, may be produced by emulsifying or dispersing the toner material liquid in an aqueous medium in which the active hydrogen group-containing compound has been previously added so that they undergo elongation reaction and/or crosslinking reaction in the aqueous medium, or may be produced by emulsifying or dispersing the toner material liquid in an aqueous medium and adding the active hydrogen group-containing compound so that they undergo elongation reaction and/or crosslinking reaction from particle interfaces in the aqueous medium. When effecting the elongation reaction and/or crosslinking reaction from particle interfaces, formation of urea-modified polyester resin is favored on the toner particle surfaces being produced; thus it is possible to form a concentration gradient of the urea-modified polyester resin in the toner particles.

The reaction conditions used for the production of the adhesive base material is not particularly limited and can be appropriately determined depending on the combinations of the polymer reactive with an active hydrogen group and the active hydrogen group-containing compound. A suitable reaction time is not particularly limited and can be appropriately selected depending on the intended purpose. It is preferably from 10 minutes to 40 hours, more preferably from 2 hours to 24 hours. A suitable reaction temperature is not particularly limited and can be appropriately selected depending on the intended purpose. It is preferably 150° C. or less, more preferably from 40° C. to 98° C.

A suitable method of stably forming a dispersion liquid containing the polymer reactive with an active hydrogen group (e.g. isocyanate group-containing polyester prepolymer) is, for example, a method in which a toner material liquid, prepared by dissolving or dispersing in a solvent a toner material containing the polymer reactive with an active hydrogen group, pigment, pigment dispersant, releasing agent, charge control agent, unmodified polyester resin, etc., is added and dispersed by shear force.

The dispersing can be achieved using any known disperser; examples thereof include a low-speed shear disperser, high-speed shear disperser, friction disperser, high-pressure and jet disperser, and supersonic disperser. Of these, the high-speed shear disperser is preferable, because it is capable of adjusting the particle diameter of the dispersion to be within a range of 2 μm to 20 μm. When the high-speed shear disperser is used, conditions like rotational speed, dispersing time, dispersing temperature, etc., can be determined depending on the intended purpose.

The rotational speed is not particularly limited and can be appropriately selected depending on the intended purpose. It is preferably 1,000 rpm to 30,000 rpm, more preferably 5,000 rpm to 20,000 rpm.

The dispersing time is not particularly limited and can be appropriately selected depending on the intended purpose. It is preferably 0.1 minutes to 5 minutes in the case of batch method.

The dispersing temperature is not particularly limited and can be appropriately selected depending on the intended purpose. It is preferably 150° C. or less, more preferably 40° C. to 98° C. under pressure. In general, dispersing can be more easily effected at higher temperatures.

The amount of the aqueous medium for emulsification or dispersing of the toner material is not particularly limited and can be appropriately selected depending on the intended purpose. It is preferably 50 parts by mass to 2,000 parts by mass, more preferably 100 parts by mass to 1,000 parts by mass relative to 100 parts by mass of the toner material. When the amount of the aqueous medium is less than 50 parts by mass, it may result in poor dispersing of toner material and thus toner base particles with a desired particle diameter cannot be obtained. When it is greater than 2,000 parts by mass, production costs may be high.

The step of emulsifying or dispersing the toner material liquid preferably employs a dispersant for the purpose of stabilizing the dispersion (e.g., oil droplets) to have a desired shape, and of obtaining a sharp particle size distribution. The dispersant can be appropriately selected depending on the intended purpose; examples thereof include surfactants, poor water-soluble inorganic dispersants, and polymeric protective colloids, with surfactants being preferable. These dispersants may be used alone or in combination.

The surfactants are not particularly limited and can be appropriately selected depending on the intended purpose. Examples thereof include anionic surfactants, cationic surfactants, nonionic surfactants, and ampholytic surfactants.

The anionic surfactants are not particularly limited and can be appropriately selected depending on the intended purpose. Examples thereof include alkylbenzene sulfonates, α-olefin sulfonates, and phosphates. Of these, those having fluoroalkyl groups are preferable. The fluoroalkyl group-containing anionic surfactants are not particularly limited and can be appropriately selected depending on the intended purpose. Examples thereof include fluoroalkyl carboxylic acids having 2 to 10 carbon atoms or metal salts thereof, disodium perfluorooctanesulfonylglutamate, sodium-3-{omega-fluoroalkyl (C6-C11)oxy}-1-alkyl(C3-C4) sulfonate, sodium-3-{omega-fluoroalkanoyl(C6-C8)-N-ethylamino}-1-propanesulfonate, fluoroalkyl(C11-C20) carboxylic acids or metal salts thereof, perfluoroalkyl(C7-C13) carboxylic acids or metal salts thereof, perfluoroalkyl(C4-C12) sulfonic acids or metal salts thereof, perfluorooctanesulfonic acid diethanol amide, N-propyl-N-(2-hydroxyethyl)perfluorooctanesulfone amide, perfluoroalkyl(C6-C10)sulfoneamidepropyltrimethylammonium salts, salts of perfluoroalkyl (C6-C10)-N-ethylsulfonyl glycin, and monoperfluoroalkyl(C6-C16)ethylphosphoric acid esters.

Examples of commercially available products of the fluoroalkyl group-containing surfactants include, but not limited to, SURFLON S-111, S-112 and S-113 (manufactured by Asahi Glass Co., Ltd.); FLUORAD FC-93, FC-95, FC-98 and FC-129 (manufactured by Sumitomo 3M Limited); UNIDYNE DS-101 and DS-102 (manufactured by Daikin Industries, Ltd.); MEGAFACE F-110, F-120, F-113, F-191, F-812 and F-833 (manufactured by Dainippon Ink and Chemicals, Incorporated); EETOP EF-102, 103, 104, 105, 112, 123A, 123B, 306A, 501, 201 and 204 (manufactured by Tohchem Products Co., Ltd.); FTERGENT 100 and 150 (manufactured by NEOS COMPANY LIMITED).

The cationic surfactants are not particularly limited and can be appropriately selected depending on the intended purpose. Examples thereof include amine salts such as alkyl amine salts, amino alcohol fatty acid derivatives, polyamine fatty acid derivatives, and imidazoline; and quaternary ammonium salts such as alkyltrimethyl ammonium salts, dialkyldimethyl ammonium salts, alkyldimethyl benzyl ammonium salts, pyridinium salts, alkyl isoquinolinium salts, and benzethonium chloride.

Of these, preferable examples are primary, secondary or tertiary fluoroalkyl group-containing aliphatic amine acids, aliphatic quaternary ammonium salts such as perfluoroalkyl(C6-C10) sulfoneamide propyl trimethyl ammonium salts, benzalkonium salts, benzetonium chloride, pyridinium salts, and imidazolinium salt.

Specific examples of the commercially available products thereof include, but not limited to, SURFLON S-121 (manufactured by Asahi Glass Co., Ltd.), FLUORAD FC-135 (manufactured by Sumitomo 3M Limited), UNIDYNE DS-202 (manufactured by Daikin Industries, Ltd.), MEGAFACE F-150 and F-824 (manufactured by Dainippon Ink and Chemicals, Incorporated), EFTOP EF-132 (manufactured by Tohchem Products Co., Ltd.), and FTERGENT F-300 (manufactured by NEOS COMPANY LIMITED).

The nonionic surfactants are not particularly limited and can be appropriately selected depending on the intended purpose. Examples thereof include fatty acid amide derivatives, and polyhydric alcohol derivatives.

The ampholytic surfactants are not particularly limited and can be appropriately selected depending on the intended purpose. Examples thereof include alanine, dodecyldi(aminoethyl)glycin, di(octylaminoethyl)glycin, and N-alkyl-N,N-dimethyl ammonium betaine.

The poor water-soluble inorganic dispersants are not particularly limited and can be appropriately selected depending on the intended purpose. Examples thereof include tricalcium phosphate, calcium carbonate, titanium oxide, colloidal silica, and hydroxyl apatite.

The polymeric protective colloids are not particularly limited and can be appropriately selected depending on the intended purpose. Examples thereof include homopolymers or copolymers prepared by polymerization of a carboxyl group-containing monomer, hydroxyl group-containing alkyl (meth)acrylate, vinyl ether, vinyl carboxylate, amide monomer, acid chloride monomer, or monomer containing a nitrogen atom or heterocyclic ring thereof; polyoxyethylene resins; and celluloses. The homopolymers or copolymers obtained by polymerization of any of the above monomers include those having vinyl alcohol-derived units.

The carboxyl group-containing monomer is not particularly limited and can be appropriately selected depending on the intended purpose. Examples thereof include acrylic acid, methacrylic acid, α-cyanoacrylic acid, α-cyanomethacrylic acid, itaconic acid, crotonic acid, fumaric acid, maleic acid, and maleic anhydride.

The hydroxyl group-containing alkyl (meth)acrylate monomer is not particularly limited and can be appropriately selected depending on the intended purpose. Examples thereof include β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycol monoacrylate, diethyleneglycol monomethacrylate, glycerin monoacrylate, and glycerin monomethacrylate.

The vinyl ether is not particularly limited and can be appropriately selected depending on the intended purpose. Examples thereof include vinyl methyl ether, vinyl ethyl ether, and vinyl propyl ether.

The vinyl carboxylate is not particularly limited and can be appropriately selected depending on the intended purpose. Examples thereof include vinyl acetate, vinyl propionate, and vinyl butyrate.

The amide monomer is not particularly limited and can be appropriately selected depending on the intended purpose. Examples thereof include acrylamide, methacrylamide, diacetone acrylicamide, N-methylolacrylamide, N-methylolmethacrylamide.

The acid chloride is not particularly limited and can be appropriately selected depending on the intended purpose. Examples thereof include acrylic chloride, and methacrylic chloride.

The monomers having a nitrogen atom or heterocyclic ring is not particularly limited and can be appropriately selected depending on the intended purpose. Examples thereof thereof include vinyl pyridine, vinyl pyrrolidone, vinyl imidazole, and ethyleneimine.

The polyoxyethylene resins are not particularly limited and can be appropriately selected depending on the intended purpose. Examples thereof include polyoxyethylene, polyoxypropylene, polyoxyethylene alkylamines, polyoxypropylene alkylamines, polyoxyethylene alkylamides, polyoxypropylene alkylamides, polyoxyethylene nonylphenylether, polyoxyethylene laurylphenylether, polyoxyethylene phenyl stearate, and polyoxyethylene phenyl pelargonate.

The celluloses are not particularly limited and can be appropriately selected depending on the intended purpose. Examples thereof include methyl cellulose, hydroxyethyl cellulose, and hydroxypropyl cellulose.

Upon emulsification or dispersing of toner material, a dispersant is used as necessary.

The dispersant is not particularly limited and can be appropriately selected depending on the intended purpose. Examples thereof include compounds capable being dissolved in acid or alkali, such as calcium phosphate. When calcium phosphate is employed, it can be removed by dissolving it in hydrochloric acid or the like and followed by washing with water, or by enzymatic decomposition.

The elongation reaction and/or crosslinking reaction for production of adhesive base material can employ a catalyst. The catalyst is not particularly limited and can be appropriately selected depending on the intended purpose. Examples include dibutyltin laurate, and dioctyltin laurate.

The method for removing the organic solvent from the obtained dispersion liquid (e.g., emulsified slurry) is not particularly limited and can be appropriately selected depending on the intended purpose. It is carried out, for example, by any of the following methods: a method in which the temperature of the whole reaction system is gradually increased for evaporation of the organic solvent in oil droplets; and a method in which the dispersion liquid is sprayed in a dry atmosphere for removal of the organic solvent from oil droplets. Once the organic solvent has been removed, toner base particles are formed. The toner particles may be washed and dried, and if necessary, can be classified. The classification is, for example, carried out using a cyclone, decanter, or centrifugal separation in the solution for removal of fine particles. Alternatively, the classification is carried out after the toner particles have been dried. The thus obtained toner base particles may be mixed with particles of such agents as a colorant, releasing agent, and/or charge control agent. At this time, mechanical impact may be applied to the toner particles so as to prevent releasing agent particles, etc., from being come off from the toner base particle surface.

The method of application of mechanical impact is not particularly limited and can be appropriately selected depending on the intended purpose. Examples thereof include a method in which impact is applied by rotating a blade at high speeds, and a method in which impact is applied by putting mixed particles into a high-speed air flow and accelerating the air speed such that the particles collide with one another or that the particles are crashed into a proper collision plate.

The device employing this method is not particularly limited and can be appropriately selected depending on the intended purpose. Examples thereof include Angmill (manufactured by Hosokawamicron Corp.), modified I-type mill (manufactured by Nippon Pneumatic Mfg. Co., Ltd.) to decrease pulverization air pressure, hybridization system (manufactured by Nara Machinery Co., Ltd.), kryptron system (manufactured by Kawasaki Heavy Industries, Ltd.), and automatic mortar.

The toner of the present invention can be used in various fields, but can be suitably used for image formation by electrophotography.

### (Developer)

A developer of the present invention contains a toner of the present invention and may further contain appropriately selected additional components such as carrier. Thus, the developer has excellent transferability, charging ability and is capable of stably forming high-quality images. The developer may be a one-component developer or two-component developer and it is preferably a two-component developer for its long life when used in high-speed printers corresponding to recent high information processing speed.

When the developer containing the toner of the present invention is used as a one-component developer, variations in toner particle diameter are small, even after toner consumption or toner supply, and toner filming to the development roller and toner fusing to members (e.g., a blade for forming a thin toner film) are prevented, and in addition, even after long-time use of the development device (i.e., long-time stirring of developer), excellent developing ability can be ensured and excellent images are obtained in a stable manner.

When the developer containing the toner of the present invention is used as a two-component developer, even after a long-time toner consumption and toner supply, variations in toner particle diameter are small, and even after long-time stirring in the development device, excellent developing ability can be ensured and excellent images are obtained in a stable manner. The carrier can be selected appropriately depending on the intended purpose and it is preferably a carrier composed of a core material and a resin layer covering the core material.

The material of the core material is not particularly limited and can be selected from those known in the art. For example, it is preferable to employ manganese-strontium (Mn—Sr) material or manganese-magnesium (Mn—Mg) material (50 emu/g to 90 emu/g), preferably high magnetization material such as iron powder (100 emu/g or more) or magnetite (75 emu/g to 120 emu/g) for the purpose of securing image density. Moreover, it is preferably a low magnetization material such as copper-zinc (Cu—Zn) with 30 emu/g to 80 emu/g because the impact toward the photoconductor having a developer in the form of magnetic brush can be relieved and because it is advantageous for higher image quality. These materials may be used alone or in combination.

The volume-average particle diameter of the core material is not particularly limited and can be appropriately selected depending on the intended purpose. It is preferably 10 μm to 150 μm, more preferably 40 μm to 100 μm. When the volume-average particle diameter is less than 10 μm, the amount of fine carrier powder increases, whereas magnetization per particle decreases and carrier scattering may occur. When the volume-average particle diameter is greater than 150 μm, the specific surface area decreases and thus toner scattering may occur; therefore, in the case of printing a full-color image composed with many solid portions, especially the reproduction of the solid portions may become insufficient.

The material of the resin layer for coating the core material is not particularly limited and can be appropriately selected from known resins depending on the intended purpose. Examples include amino resins, polyvinyl resins, polystyrene resins, halogenated olefins, polyester resins, polycarbonate resins, polyethylene, polyvinyl fluoride, polyvinylidene fluoride, polytrifluoroethylene, polyhexafluoropropylene, copolymers of vinylidene fluoride and acrylic monomer, copolymers of vinylidene fluoride and vinyl fluoride, fluoroterpolymers such as terpolymers of tetrafluoroethylene, vinylidene fluoride and monomer having no fluoro group, and silicone resins. These may be used alone or in combination.

The amino resins are not particularly limited and can be appropriately selected depending on the intended purpose. Examples thereof include urea-formaldehyde resins, melamine resins, benzoguanamine resins, urea resins, polyamide resins, and epoxy resins.

The polyvinyl resins are not particularly limited and can be appropriately selected depending on the intended purpose. Examples thereof include acrylic resins, polymethylmetacrylate, polyacrylonitrile, polyvinyl acetate, polyvinyl alcohol, and polyvinyl butyral.

The polystyrene resins are not particularly limited and can be appropriately selected depending on the intended purpose. Specific examples thereof include polystyrene and styrene-acrylic copolymers.

The halogenated polyolefins are not particularly limited and can be appropriately selected depending on the intended purpose. Examples thereof include polyvinyl chloride.

The polyester resins are not particularly limited and can be appropriately selected depending on the intended purpose. Examples thereof include polyethylene terephtalate and polybutylene terephtalate.

The resin layer may contain conductive powder or the like as necessary. The conductive powder is not particularly limited and can be appropriately selected depending on the intended purpose. Examples thereof include metal powder, carbon black, titanic oxide, tin oxide, and zinc oxide. The average particle diameter of these conductive powders is not particularly limited and can be appropriately selected depending on the intended purpose. It is preferably 1 μm or less. When the average particle diameter is greater than 1 μm, it may be difficult to control the electrical resistance.

The resin layer may be formed by uniformly coating a surface of the core material with a coating solution obtained by dissolving a silicone resin or the like in a solvent, by a known coating method, followed by drying and baking. The coating method is not particularly limited and can be appropriately selected depending on the intended purpose. Examples thereof include dipping, spraying, and brushing. The solvent is not particularly limited and can be selected accordingly and examples thereof include toluene, xylene, methyl ethyl ketone, methyl isobutyl ketone, cellosolve, and butyl acetate. The baking is not particularly limited and can be external heating or internal heating and examples of baking methods include methods using fixed electric furnace, fluid electric furnace, rotary electric furnace, or burner furnace, and methods using microwaves.

The amount of resin layer in the carrier is not particularly limited and can be appropriately selected depending on the intended purpose. It is preferably 0.01% by mass to 5.0% by mass. When the amount is less than 0.01% by mass, the resin layer may not be uniformly formed over the surface of the core material. When the amount is more than 5.0% by mass, the resin layer becomes so thick that fusing of carrier particles occur and thus equally-sized carrier particles may not be obtained.

The carrier content in the two-component developer is not particularly limited and can be appropriately selected depending on the intended purpose. It is preferably 90% by mass to 98% by mass, more preferably 93% by mass to 97% by mass.

The developer containing the toner of the present invention can be used in known image formation methods using electrophotography, such as magnetic one-component developing method, non-magnetic one-component developing method, two-component developing method or the like.

### (Process Cartridge and Image Forming Apparatus)

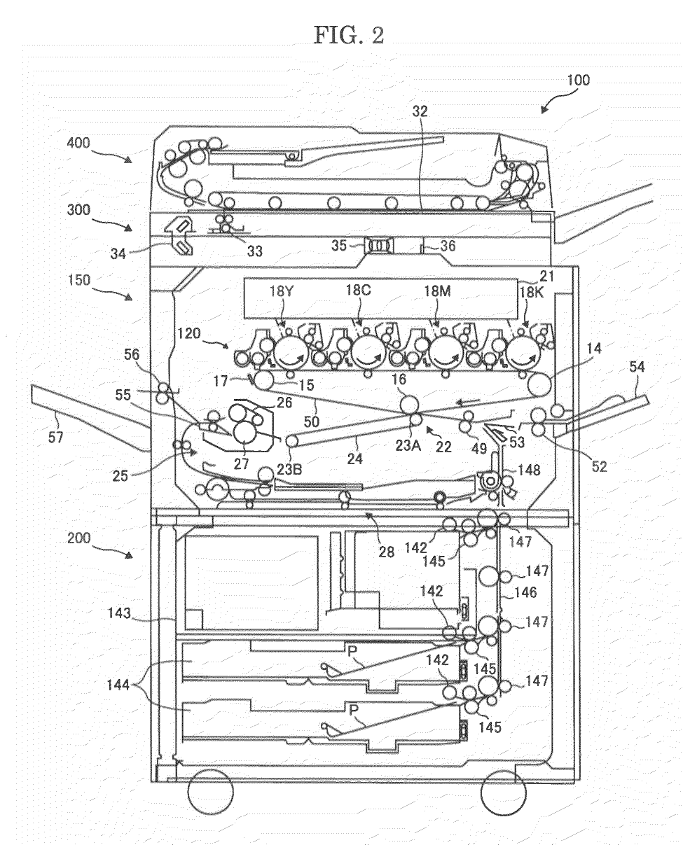

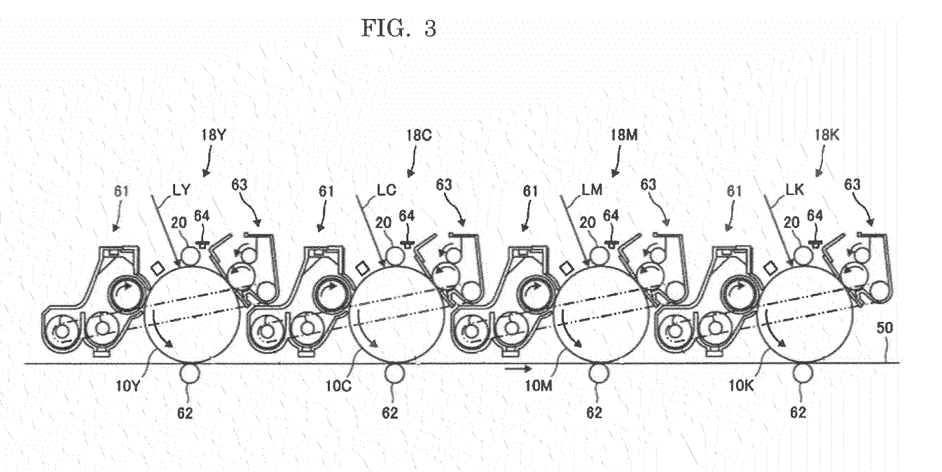

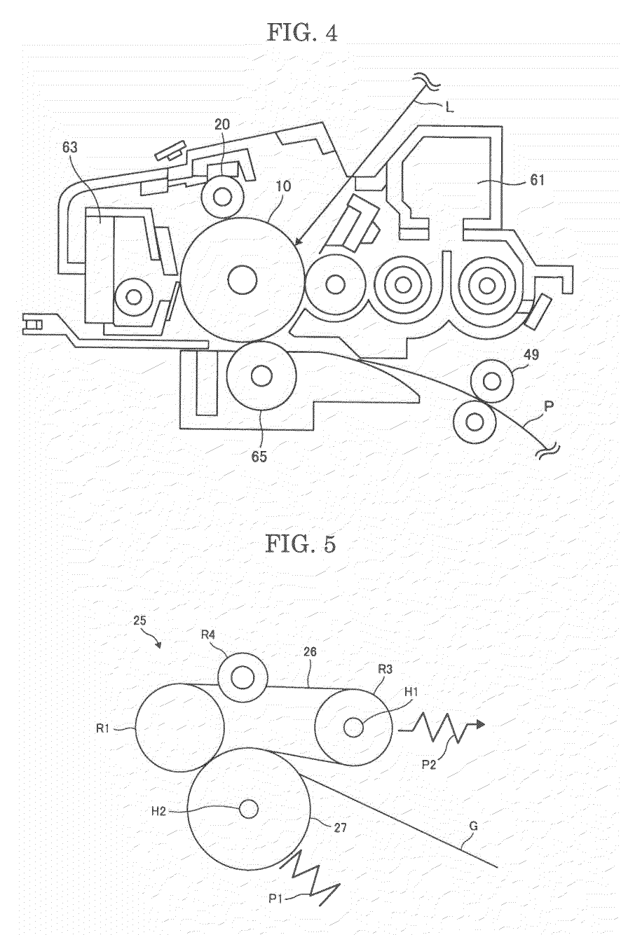

Next, an embodiment of an image forming apparatus using the toner of the present invention will be described with reference to FIGS. 2 to 4. FIG. 2 is a schematic structural diagram showing an example of an image forming apparatus according to an embodiment of the present invention. FIG. 3 is a schematic structural diagram of the tandem image forming unit shown in FIG. 2. FIG. 4 is a schematic structural diagram showing an example of a process cartridge according to an embodiment of the present invention.

Image forming apparatus shown in FIG. 2 is a tandem color image forming apparatus. An image forming apparatus 100 contains a copy machine main body 150, a feeder table 200, a scanner 300, and an automatic document feeder (ADF) 400.

The copy machine main body 150 has an endless-belt intermediate transfer medium 50 in the center. The intermediate transfer medium 50 is stretched around support rollers 14, 15 and 16 and is configured to be rotatable in a clockwise direction in FIG. 2. A cleaning unit for intermediate transfer medium 17 configured to remove toner particles remained on the intermediate transfer medium 50 is provided in the vicinity of the support roller 15. On the intermediate transfer medium 50 stretched around the support rollers 14 and 15, four color image forming units 18Y, 18C, 18M, 18K—yellow, cyan, magenta, and black—are aligned along the conveying direction so as to face the intermediate transfer medium 50, which constitutes a tandem image forming unit 120. An exposing unit 21 is arranged adjacent to the tandem image forming unit 120. A secondary transferring unit 22 is arranged on a side opposite to the tandem image forming unit 120 via the intermediate transfer medium 50.

The secondary transferring unit 22 contains a secondary transferring belt 24, which is an endless belt and stretched around a pair of rollers 23A and 23B. A recording paper P, which is a recording medium conveyed on the secondary transferring belt 24 is allowed to be contacted with the intermediate transfer medium 50. An image fixing unit 25 is arranged in the vicinity of the secondary transferring unit 22. The image fixing unit 25 contains a fixing belt 26 which is an endless belt, and a pressurizing roller 27 which is pressed by the fixing belt 26. A sheet reverser 28 is arranged adjacent to both the secondary transferring unit 22 and the image fixing unit 25. The sheet reverser 28 turns over the recording paper P to form images on the both sides thereof.

Next, full-color image formation (color copying) using the tandem image forming unit 120 will be described. At first, a source document is placed on a document tray of the automatic document feeder 400. Alternatively, the automatic document feeder 400 is opened, the source document is placed on a contact glass 32 of the scanner 300, and the automatic document feeder 400 is closed.

When a start switch (not shown) is pushed, a document, if any, placed on the automatic document feeder 400 is transferred onto the contact glass 32. When the document is initially placed on the contact glass 32, the scanner 300 is immediately driven to operate a first carriage 33 and a second carriage 34. Light is applied from a light source to the document, and reflected light from the document is further reflected toward the second carriage 34 at the first carriage 33. The reflected light is further reflected with a mirror of the second carriage 34 and passes through image-forming lens 35 into a read sensor 36 to thereby read the document, and form image information of black, yellow, magenta, and cyan. Next, each image information is transferred to the individual image forming units 18Y, 18C, 18M, 18K in the tandem image forming unit 120, to thereby form respective visible images of black, yellow, magenta, and cyan colors.

As shown in FIG. 3, image forming units 18Y, 18C, 18M, 18K respectively include drum-shaped photoconductors 10Y, 10C, 10M, 10K, charging units 20 for uniformly charging the photoconductors 10Y, 10C, 10M, 10K, developing units 61Y, 61C, 61M, 61K for developing latent electrostatic images so as to form visible images of respective toners (toner images) by supplying respective toners (a black toner, a yellow toner, a magenta toner, a cyan toner) to the latent electrostatic images corresponding to respective colors formed by exposing the photoconductors 10Y, 10C, 10M, 10K with an exposing unit 21 based on the image information corresponding to respective colors, a primary transfer charger (a primary transfer charging unit) 62 for transferring the visible imaged on an intermediate transfer medium 50, a cleaning unit 63 and a charge eliminating unit 64, and the image forming units 18Y, 18C, 18M, 18K can form visible images of respective colors based on respective image information. Next, the visible images of respective colors are sequentially transferred (primary transferred) from the photoconductors 10Y, 10C, 10M, 10K to the intermediate transfer medium 50 which is rotationally moved by support rollers 14, 15 and 16, and respective visible images (toner images) are superimposed to form a transferred composite image (color toner image).

Meanwhile, as shown in FIG. 2, one of feed rollers 142 of the feed table 200 is selected and rotated, whereby sheets (recording paper P) are ejected from one of multiple feed cassettes 144 in a paper bank 143 and are separated one by one by a separation roller 145. Thereafter, the sheets are fed to feed path 146, transferred by a transfer roller 147 into a feed path 148 inside the copying machine main body 150, and are bumped against the resist roller 49 to stop. Alternatively, one of the feed rollers 142 is rotated to eject sheets (recording paper P) placed on a manual feed tray 54. The sheets are then separated one by one by means of the separation roller 52, fed into a manual feed path 53, and similarly, bumped against the resist roller 49 to stop. Note that the resist roller 49 is generally earthed, but it may be biased for removing paper dusts on the sheets. The resist roller 49 is rotated synchronously with the movement of the composite color image (color transferred image) on the intermediate transfer medium 50 to transfer the sheet (recording paper P) into between the intermediate transfer medium 50 and the secondary transferring unit 22, and the composite color image (color transferred image) is transferred onto the sheet (recording paper) by means of the secondary transferring unit 22 (secondary transferring). In this way the color image is formed on the sheet (recording paper P). After image transferring, toner particles remained on the intermediate transfer medium 50 are cleaned by means of the cleaning unit 17 for intermediate transfer medium 50.

The sheet (recording paper P), on which the transferred color image is formed, is conveyed by the secondary transferring unit 22 into the image fixing unit 25, where the composite color image (color transferred image) is fixed onto the sheet (recording paper P) by heat and pressure. Thereafter, the sheet changes its direction by action of a switch hook 55, ejected by an ejecting roller 56, and stacked on an output tray 57. Alternatively, the sheet changes its direction by action of the switch hook 55, flipped over by means of the sheet reverser 28, and transferred back to the image transfer section for recording of another image on the other side. The sheet that bears images on both sides is then ejected by means of the ejecting roller 56, and is stacked on the output tray 57.

According to the image forming apparatus of the present invention, an image can be stably fixed on a recording medium without forming an abnormal image even at high process linear velocity using the image forming toner, because the toner has excellent low-temperature fixing ability and heat-resistant storage stability at high speed printing, and enables an image to stably fix on a desired position of the recording medium without occurring offset phenomenon. For example, by using the above-mentioned tandem full color image forming apparatus, an image having high quality can be formed at higher speed. The image forming apparatus of the present invention can widely apply to an electrophotographic application field using electrophotography such as electrostatic copiers or laser beam printers and the like. The tandem image forming apparatus can simultaneously transfer multiple toner images, so that high speed full color printing can be achieved.

The above-described tandem image forming unit 120 may be mounted and fixed in a copier, facsimile, or printer. Alternatively, it can be mounted in the apparatus in a form of a process cartridge.

The process cartridge is a device (component) which includes a latent electrostatic image bearing member (photoconductor), and further includes a unit selected from a charging unit, an exposing unit, a developing unit, a transfer unit, and a cleaning unit. The process cartridge of the present invention includes a drum-shaped photoconductor as a latent electrostatic image bearing member and at least a developing unit, which are integrally connected and detachably mounted in the image forming apparatus, thereby easily performing operation of maintenance, check, and replacement. The process cartridge according to an embodiment of the present invention will be described with reference to FIG. 4.

As shown in FIG. 4, a process cartridge of the present invention integrally includes a drum-shaped photoconductor 10 as a latent electrostatic image bearing member, a charging roller 20 which uniformly charges a surface of the photoconductor 10, a developing unit 61 which develops a latent electrostatic image that has been formed on a charged surface of the photoconductor 10 by means of an exposure L from an exposing unit 21 while supplying a toner to the latent electrostatic image so as to form a toner image, and a cleaning unit 63 which removes toner remaining on the surface of the photoconductor 10 after the toner image formed on the surface of the photoconductor 10 is transferred onto a recording medium P by means of a transfer unit 65. The process cartridge is detachably mounted in a main body of an image forming apparatus. In this case, it is not necessary to integrate the photoconductor 10 with all of the charging roller 20, the developing unit 61, and the cleaning unit 63, but the photoconductor 10 is integrated with at least the developing unit 61. The developing unit 61 contains the toner for image formation of the present invention. Thus, in the fixing unit 25 (see FIG. 2), offset phenomenon does not occur due to an unfixed image, and an image is stably fixed only on a desired position of the recording medium P, thereby printing a high quality image. The process cartridge is excellent in handleability, such as easiness of storage and transportation.

When the toner of the present invention is supplied to the developing unit mounted in the above-mentioned image forming apparatus, the toner can be supplied in the developing unit as a toner container such as a cylindrical-shaped or pouched container, as necessary.

### EXAMPLES

The present invention will be described in more detail with reference to the following Examples and Comparative Examples. However, it should be noted that the present invention is not limited by these Examples and Comparative Examples. In the Examples, “part(s)” and “%” are by mass, and “mole” means molar ratio, unless otherwise specified.

“BET specific surface area of toner”, “Average circularity of toner”, “Volume-average particle diameter of toner”, “Total amount of wax in toner”, and “Measurement of mass reduction of wax at 165° C.” were measured as follows.

### <BET Specific Surface Area of Toner>

The BET specific surface area of a toner was measured with a automatic surface area and porosimetry analyzer (TriStar 3000: available from Shimadzu Corporation). Specifically, about 0.5 g of a sample was weighed in a sample cell, and it was vacuum dried using a pretreatment system smartprep (available from Shimadzu Corporation) for 24 hours, and then impurities and water on the sample surface were removed. The pretreated sample was set in TriStar 3000 to obtain the relation between a nitrogen gas adsorption and a relative pressure. Based on this relation, the BET specific surface area of the sample was obtained by a multipoint BET method.

### <Average Circularity of Toner>

The average circularity of the toner was measured using the flow-type particle image analyzer FPIA-2000 (produced by Sysmex Corporation). Specifically, 0.1 mL to 0.5 mL of a surfactant, preferably alkylbenzene sulfonate, was added as a dispersant into 100 mL to 150 mL of water in a container, from which solid impurities had previously been removed. Then, approximately 0.1 g to approximately 0.5 g of a measurement sample was added. The suspension in which the sample was dispersed was subjected to dispersing treatment by an ultrasonic dispersing device for approximately 1 minute to approximately 3 minutes, and the concentration of the dispersed solution was adjusted such that the number of particles of the sample was 3,000 per microliter to 10,000 per microliter. Under this condition, the particle shape and particle size of the toner were measured using the analyzer.

### <Total Amount of Wax in Toner>

The total amount of wax contained in the toner particles was determined by a differential scanning calorimeter (DSC) method. Specifically, a toner sample and a sample of wax sole were respectively measured using the following measurement device under the following conditions so as to obtain endothermic values of the waxes. The total amount of the wax contained in the toner particles was obtained based on the ratio between the resultant endothermic values of the waxes in the samples.

Measurement device: DSC device (DSC60, manufactured by Shimadzu Corporation)

Sample amount: about 5 mg

Temperature rising speed: 10° C./min

Measurement range: room temperature to 150° C.

Measurement environment: in nitrogen gas atmosphere

The amount of the wax is calculated by the following Equation (1).

The total amount of wax (% by mass)=(Endotherm (J/g) of wax of a toner sample)×100/(Endotherm (J/g) of a wax single substance) Equation (1)

### <Average Particle Diameter of Toner>

The volume-average particle diameter (Dv), number average particle diameter (Dn), and Dv/Dn of toner were measured by a particle size analyzer (Multisizer III, manufactured by Beckman Coulter, Inc.) at an aperture diameter of 100 μm using analysis software (Beckman Coulter Multisizer 3 Version 3.51). More specifically, 0.5 mL of 10% surfactant (NEOGEN SC-A, alkylbenzenesolfonate, manufactured by Daiichi Kogyo Seiyaku Co., Ltd.) was placed in a 100-mL glass beaker, 0.5 g of each toner was added in the beaker and mixed together using a microspatula, and 80 mL of ion-exchanged water was added. The resultant dispersion liquid was subjected to dispersing treatment for 10 minutes with W-113MK-II, an ultrasonic disperser manufactured by HONDA ELECTRONICS Co., Ltd. For analysis, the aforementioned Multisizer III was used and ISOTON III (Beckman Coulter Inc.) was used as a measurement solution. In the measurement the toner sample dispersion liquid was dropped so that the concentration indicated by the device was 8%±2%. It is important to keep the concentration within 8%±2% in view of the reproducibility of particle size measurement. In this concentration range there would be no error in the measured particle size.

### <Measurement of Mass Reduction of Wax at 165° C.>

In the present invention, measurement of mass reduction of wax at 165° C. was determined in the following manner using TA-60WS and DSC-60 (manufactured by Shimadzu Corporation) as a measurement device under the conditions described below.

### Measurement Conditions

Sample container: aluminum sample pan

Sample amount: 5 mg

Reference: aluminum sample pan (a sample pan alone)

Atmosphere: nitrogen (flow rate: 50 mL/min)

Temperature condition:
Start temperature: 20° C.
Heating rate: 10° C./min
Finish temperature: 165° C.
Hold time: 60 min

The measured results were analyzed using the above-mentioned data analysis software (TA-60, version 1.52) available from Shimadzu Corporation. The analysis method of mass reduction at 165° C. was calculated by the following equation, in which A is defined as a mass of the wax at 165° C. and at 0 minutes, and B is defined as a mass of the wax which have been maintained at 165° C. for 60 minutes.

Mass reduction at 165° C.=(A−B)/A×100

### Example 1-1

### Synthesis of Unmodified Polyester (Low Molecular Mass Polyester)

A reaction vessel equipped with a reflux condenser, stirrer and gas inlet tube was charged with 229 parts of bisphenol A ethylene oxide (2 mol) adduct, 528 parts of bisphenol A propyleneoxide (3 mol) adduct, 207 parts of terephthalic acid, 45 parts of adipic acid and 2 parts of dibutyltin oxide, and reacted for 7 hours at 230° C. under normal pressure. After 5-hour reaction under reduced pressure of 10 mmHg to 15 mmHg, 43 parts of trimellitic anhydride was added and reacted for 2 hours at 185° C. under normal pressure to synthesize an unmodified polyester.

The unmodified polyester thus obtained had a number-average molecular mass (Mn) of 2,600, mass-average molecular mass (Mw) of 6,600, glass transition temperature (Tg) of 44° C., and acid value of 23 mgKOH/g.

### —Preparation of Master Batch (MB-1)—

In a reaction vessel, 1,200 parts of water, 540 parts of carbon black (Printex 35, manufactured by Degussa Co., DBP oil absorption=42 mL/100 g, pH=9.5) as a colorant, and 1,210 parts of the synthesized unmodified polyester were mixed with HENSCHEL MIXER (manufactured by Mitsui Mining Co., Ltd.). The obtained mixture was kneaded for 40 minutes at 160° C. using two rolls, and thereafter rolled and cooled, and milled with a pulverizer (manufactured by Hosokawa Micron Corporation) to prepare a master batch 1 (MB-1).

### —Synthesis of Wax Dispersant—

In an autoclave reaction vessel equipped with a thermometer and a stirrer, 600 parts of xylene and 300 parts of low molecular mass polyethylene (SANWAX LEL-400, manufactured by Sanyo Chemical Industries, Ltd., softening point of 128° C.) were placed such that the polyethylene was sufficiently dissolved in the xylene, then purged with nitrogen. Thereafter, a mixed solution of 2,310 parts of styrene, 270 parts of acrylonitrile, 150 parts of butyl acrylate, and 78 parts of di-t-butyl peroxyhexahydroterephthalate, 455 parts of xylene was applied dropwise at 175° C. for 3 hours to effect polymerization, then the mixture was held at this temperature for 30 minutes. Subsequently, the solvent was removed to thereby obtain a wax dispersant.

### —Preparation of Wax Dispersion Liquid (1-1)—

In a reaction vessel equipped with a stirring rod and a thermometer, 378 parts of the unmodified polyester, 110 parts of a paraffin wax (VICTORY WAX manufactured by TOYO ADL CORPORATION; a melting point of 52° C., a melt viscosity at 140° C. of 12 mPa·s), 49.5 parts of the synthesized wax dispersant, and 947 parts of ethyl acetate were charged, and heated at 85° C. while stirring, and held at 85° C. for 5 hours. Thereafter, the resultant product was cooled to 30° C. for 1 hour, to thereby obtain a wax dispersion liquid (1-1).

### —Preparation of Organic Solvent Phase—

The prepared wax dispersion liquid (1-1) in an amount equivalent to 4.0 parts of the wax in the toner was charged together with 500 parts of the prepared master batch (MB-1) and 500 parts of ethyl acetate, followed by mixing 2 hours to thereby obtain a material solution. The resultant material solution (1,324 parts) was placed in a reaction vessel, and the carbon black and the wax were dispersed by using a bead mill (Ultra Visco Mill, manufactured by Imex Co., Ltd.) under the conditions of a liquid feed rate of 1 kg/hr, disc circumferential velocity of 7 m/s, 0.5 mm zirconia beads packed to 80% by volume, and 3 passes. Then, 1,325 parts of 65% ethyl acetate solution of the synthesized unmodified polyester was added in the dispersion liquid. The resultant mixture was dispersed by using the bead mill (Ultra Visco Mill, manufactured by Imex Co., Ltd.) under the conditions of a liquid feed rate of 1 kg/hr, disc circumferential velocity of 7 m/s, 0.5 mm zirconia beads packed to 80% by volume, and 1 pass, to thereby prepare an organic solvent phase. The resultant organic solvent phase had 50% in a solid content concentration (measurement condition: heating at 130° C. for 30 minutes).

### —Synthesis of Prepolymer—

In a reaction vessel equipped with a cooling tube, a stirrer and a nitrogen inlet tube, 682 parts of a bisphenol A ethylene oxide (2 mol) adduct, 82 parts of a bisphenol A propylene oxide (2 mol) adduct, 283 parts of terephthalic acid, 23 parts of trimellitic anhydride and 2 parts of dibutyltin oxide were loaded, and reacted under normal pressure at 235° C. for 7 hours. Subsequently, the resultant mixture was reacted for 5 hours under reduced pressure of 10 mmHg to 15 mmHg to obtain an intermediate polyester 1-1. The obtained intermediate polyester 1-1 had a number average molecular mass of 2,300, a mass average molecular mass of 9,750, peak molecular mass of 3,100, a glass transition temperature (Tg) of 53° C., an acid value of 0.7 mgKOH/g, and a hydroxyl value of 50 mgKOH/g.

Then, in a reaction vessel equipped with a cooling tube, a stirrer, and a nitrogen inlet tube, 411 parts of the intermediate polyester 1-1, 87 parts of isophorone diisocyanate, and 500 pars of ethyl acetate were loaded, and reacted for 5 hours at 100° C. to obtain a prepolymer 1-1. The obtained prepolymer 1-1 had 1.42% of a free isocyanate.

### —Synthesis of Ketimine (Compound Containing an Active Hydrogen Group)—

In a reaction vessel equipped with a stirring rod and a thermometer, 170 parts of isophorone diamine and 75 parts of methyl ethyl ketone were charged, and reacted at 50° C. for 5 hours to synthesize a ketimine compound (compound containing an active hydrogen group). The obtained ketimine compound (active hydrogen group-containing compound) had an amine value of 418.

### —Preparation of Toner Material Liquid—

In a reaction vessel, 748 parts of the prepared organic solvent phase, 114 parts of the synthesized prepolymer, and 2.8 parts of the synthesized ketimine compound were charged, and mixed using TK HOMOMIXER (manufactured by PRIMIX Corporation) for 1 minute at 7.3 m/s to prepare a toner material liquid.

### —Preparation of Organic Resin Fine Particle Dispersion Liquid—

Into a reaction vessel equipped with a stirring rod and a thermometer, 683 parts of water, 22 parts of a sodium salt of a sulfate ester of methacrylic acid ethylene oxide adduct (ELEMINOL RS-30, manufactured by Sanyo Chemical Industries Ltd.), 78 parts of styrene, 78 parts of methacrylic acid, 120 parts of butyl acrylate, and 1 part of ammonium persulfate were charged, and stirred at 450 rpm for 15 minutes to obtain a white emulsion. The emulsion was heated at a system temperature of 75° C. and then reacted for 5 hours. Further, 30 parts of a 1% aqueous ammonium persulfate solution was mixed thereto, and the resultant mixture was matured at 75° C. for 5 hours to prepare an aqueous dispersion liquid (an organic resin fine particle dispersion liquid) of vinyl resin particles (a copolymer of styrene-methacrylic acid-butyl acrylate-a sodium salt of a sulfate ester of methacrylic acid ethylene oxide adduct).

The volume average particle diameter (Dv) of the organic resin fine particles contained in the prepared organic resin fine particle dispersion liquid was measured by a particle size distribution measurement device (nanotrac UPA-150EX, manufactured by Nikkiso Co., Ltd.), and it was 54 nm. Further, a part of the organic resin fine particle dispersion liquid was dried to isolate a resin content. The resin content had a glass transition temperature (Tg) of 48° C., and a mass average molecular mass (Mw) of 440,000.

### Preparation of Aqueous Medium—

Water (990 parts), 37 parts of an aqueous solution of 48.5% a surfactant (dodecyldiphenyl ether sodium disulfonate) (ELEMINOL MON-7, manufactured by Sanyo Chemical Industries Ltd.), 15 parts of the prepared organic resin fine particle dispersion liquid and 91 parts of ethyl acetate were mixed and stirred to prepare an opaque white liquid. The resultant product was an aqueous medium.

### —Measurement of Critical Micelle Concentration—

The critical micelle concentration of the surfactant was measured by the following method. By using a surface tensiometer Sigma (KSV Instruments Ltd.), analysis was performed with an analysis program in the Sigma system. The surfactant was applied dropwise to an aqueous medium in increments of 0.01%, stirred and left to stand, and thereafter a surface tension was measured. From the resultant surface tension curve, the concentration of the surfactant, in which the surface tension was not decreased even though the surfactant was applied dropwise was obtained as the critical micelle concentration. The critical micelle concentration of the surfactant (sodium dodecyldiphenylether disulfonate) relative to the aqueous medium of Example 1-1 was measured with the surface tensiometer Sigma. It was 0.05% relative to the mass of the aqueous medium.

### —Emulsification or Dispersion—

The prepared aqueous medium (1,210 parts) was added to the prepared toner material liquid, and mixed using TK HOMOMIXER (manufactured by PRIMIX Corporation) for 20 minutes at a circumferential speed of 18 m/s to prepare a 0/W dispersion liquid (emulsion slurry).

### —Removal of Organic Solvent—

In a reaction vessel equipped with a stirrer and a thermometer, the emulsion slurry was placed after the emulsification or dispersion step (i.e. particle size was adjusted), a solvent was removed at 30° C. for 7 hours, and maturation was effected at 45° C. for 5 hours to produce a dispersion slurry.

### —Washing and Drying—

After 100 parts of the dispersed slurry was filtrated under reduced pressure, washing and drying were performed as follows:

(i) One hundred (100) parts of ion-exchanged water was added to the filter cake, mixed using the TK HOMOMIXER at a rotational frequency of 10.0 m/s for 10 minutes and subsequently filtered.

(ii) One hundred (100) parts of ion-exchanged water was added to the filter cake of (i), mixed using the TK HOMOMIXER at a rotational frequency of 12.0 m/s for 10 minutes and subsequently filtered under reduced pressure.

(iii) One hundred (100) parts of a 10% sodium hydroxide aqueous solution was added to the filter cake of (ii), mixed using the TK HOMOMIXER at a rotational frequency of 11.0 m/s for 10 minutes and subsequently filtered.

(iv) Three hundred ten (310) parts of ion-exchanged water was added to the filter cake of (iii), mixed using the TK HOMOMIXER at a rotational frequency of 11.0 m/s for 10 minutes and subsequently filtered. These operations were performed twice to obtain the final filter cake.

### —Surface Treatment Step—

To the resultant filter cake in the washing, 300 parts of ion-exchanged water was added, and stirred with the TK HOMOMIXER at 7,000 rpm, to thereby produce a toner dispersion liquid. The toner dispersion liquid was heated at 60° C., and the temperature T1 (T1=60° C.) was held for 40 minutes, and then the toner dispersion was cooled. Thereafter, a conductivity of the toner dispersion liquid was measured. Based on the calibration curve of the surfactant concentration, which had been obtained in advance, the surfactant concentration of the toner dispersion liquid was calculated as 0.05%. Next, filtration was performed.

### —Drying—

The resultant final filter cake was dried by a circular wind dryer at 45° C. for 48 hours, and sieved with a mesh having 75 μm openings to obtain toner base particles of Example 1-1.

### —External Additive Treatment—

To the resultant toner base particles of Example 1-1 (100 parts), 1.4 parts of hydrophobic silica as an external additive and 0.7 parts of hydrophobic titanium oxide were added and mixed using HENSCHEL MIXER (manufactured by Mitsui Mining Co., Ltd.). The mixture was sieved with a mesh having 35 μm openings, to thereby produce a toner of Example 1-1. FIG. 1 shows a TEM photograph of the cross section of the toner of Example 1-1 (magnification of 100,000).

The volume average particle diameter (Dv), number average particle diameter (Dn), particle size distribution (volume average particle diameter (Dv)/number average particle diameter (Dn)) of the resultant toner were measured by the above-mentioned methods.

### Example 1-2

A toner of Example 1-2 was produced in the same manner as in Example 1-1, except that the paraffin wax (VICTORY WAX, manufactured by TOYO ADL CORPORATION; a melting point of 52° C., a melt viscosity at 140° C. of 12 mPa·s) in Example 1-1 was replaced by microcrystalline wax (BE SQUARE 185 Wax, manufactured by TOYO ADL CORPORATION; a melting point of 60° C., a melt viscosity at 140° C. of 9 mPa·s).

### Example 1-3

A toner of Example 1-3 was produced in the same manner as in Example 1-1, except that the paraffin wax (VICTORY WAX, manufactured by TOYO ADL CORPORATION; a melting point of 52° C., a melt viscosity at 140° C. of 12 mPa·s) in Example 1-1 was replaced by microcrystalline wax (BE SQUARE 195 Wax, manufactured by TOYO ADL CORPORATION; a melting point of 77° C., a melt viscosity at 140° C. of 10 mPa·s).

### Example 1-4

A toner of Example 1-4 was produced in the same manner as in Example 1-1, except that the paraffin wax (VICTORY WAX, manufactured by TOYO ADL CORPORATION; a melting point of 52° C., a melt viscosity at 140° C. of 12 mPa·s) in Example 1-1 was replaced by microcrystalline wax (BE SQUARE 185 Wax, manufactured by TOYO ADL CORPORATION; a melting point of 60° C., a melt viscosity at 140° C. of 9 mPa·s), that the amount of the wax charged was changed from 4 parts to 1.5 parts, and that the temperature of the toner dispersion liquid was changed from 60° C. to 70° C.

### Example 1-5

A toner of Example 1-5 was produced in the same manner as in Example 1-1, except that the wax dispersion liquid (1-1) was changed to the wax dispersion liquid (1-2) descried hereinbelow, that the amount of the wax charged was changed from 4 parts to 8 parts, and that the temperature of the toner dispersion liquid was changed from 60° C. to 70° C.

### —Synthesis of Wax Dispersant—

In an autoclave reaction vessel equipped with a thermometer and an stirrer, 600 parts of xylene and 300 parts of low molecular mass polyethylene (SANWAX LEL-400, manufactured by Sanyo Chemical Industries, Ltd., softening point of 128° C.) were placed such that the polyethylene was sufficiently dissolved in the xylene, then purged with nitrogen. Thereafter, a mixed solution of 2,310 parts of styrene, 270 parts of acrylonitrile, 150 parts of butyl acrylate, and 78 parts of di-t-butyl peroxyhexahydroterephthalate, 455 parts of xylene was applied dropwise at 175° C. for 3 hours to effect polymerization, then the mixture was held at 175° C. for 30 minutes. Subsequently, the solvent was removed to thereby obtain a wax dispersant.

### —Preparation of Wax Dispersion Liquid (1-2)—

In a reaction vessel equipped with a stirring rod and a thermometer, 218.5 parts of the synthesized unmodified polyester, 220 parts of a paraffin wax (VICTORY WAX, manufactured by TOYO ADL CORPORATION; a melting point of 52° C., a melt viscosity at 140° C. of 12 mPa·s), 99 parts of the synthesized wax dispersant, and 947 parts of ethyl acetate were charged, and heated at 80° C. while stirring, and held at 80° C. for 7 hours. Thereafter, the resultant product was cooled to 30° C. for 2 hours, to thereby obtain a wax dispersion liquid (1-2).

### Example 1-6

A toner of Example 1-6 was produced in the same manner as in Example 1-2, except that the temperature of the toner dispersion liquid in the surface treatment step was changed from 60° C. to 73° C.

### Comparative Example 1-1

A toner of Comparative Example 1-1 was produced in the same manner as in Example 1-1, except that the paraffin wax (VICTORY WAX, manufactured by TOYO ADL CORPORATION; a melting point of 52° C., a melt viscosity at 140° C. of 12 mPa·s) was replaced by paraffin HNP-10 (manufactured by NIPPON SEIRO CO., LTD., melting point of 75° C., a melt viscosity at 140° C. of 4 mPa·s).

### Comparative Example 1-2

A toner of Comparative Example 1-2 was produced in the same manner as in Example 1-1, except that a paraffin wax (VICTORY WAX, manufactured by TOYO ADL CORPORATION; a melting point of 52° C., a melt viscosity at 140° C. of 12 mPa·s) was replaced by paraffin LUVAX2191 (manufactured by NIPPON SEIRO CO., LTD., a melting point of 83° C., a melt viscosity at 140° C. of 19 mPa·s).

### Comparative Example 1-3

A toner of Comparative Example 1-3 was produced in the same manner as in Example 1-1, except that the wax dispersion liquid (1-1) was replaced by a wax dispersion liquid (1-3) described hereinbelow, and that the amount of the wax charged was changed from 4 parts to 10 parts.

### —Synthesis of Wax Dispersant—

In an autoclave reaction vessel equipped with a thermometer and an stirrer, 600 parts of xylene and 300 parts of low molecular mass polyethylene (SANWAX LEL-400, manufactured by Sanyo Chemical Industries, Ltd., softening point of 128° C.) were placed such that the polyethylene was sufficiently dissolved in the xylene, then purged with nitrogen. Thereafter, a mixed solution of 2,310 parts of styrene, 270 parts of acrylonitrile, 150 parts of butyl acrylate, and 78 parts of di-t-butyl peroxyhexahydroterephthalate, 455 parts of xylene was applied dropwise at 175° C. for 3 hours to effect polymerization, then the mixture was held at 175° C. for 30 minutes. Subsequently, the solvent was removed to thereby obtain a wax dispersant.

### —Preparation of Wax Dispersion Liquid (1-3)

In a reaction vessel equipped with a stirring rod and a thermometer, 163.5 parts of the synthesized unmodified polyester, 275 parts of a paraffin wax (VICTORY WAX, manufactured by TOYO ADL CORPORATION; a melting point of 52° C., a melt viscosity at 140° C. of 12 mPa·s), 123.75 parts of the synthesized wax dispersant, and 947 parts of ethyl acetate were charged, and heated at 80° C. while stirring, and held at 80° C. for 4 hours. Thereafter, the resultant product was cooled to 30° C. for 1 hour, to thereby obtain wax dispersion liquid (1-3).

### Comparative Example 1-4

A toner of Comparative Example 1-4 was produced in the same manner as in Example 1-2, except that the temperature of the toner dispersion liquid in the surface treatment step was changed from 60° C. to 40° C.

### Comparative Example 1-5

A toner of Comparative Example 1-5 was produced in the same manner as in Example 1-2, except that the temperature of the toner dispersion liquid of the surface treatment step was changed from 60° C. to 95° C.

The properties and amount of the wax charged, and the temperature of the toner dispersion liquid of Example 1-1 to Example 1-6 and Comparative Example 1-1 to Comparative Example 1-5 are as shown in Table 1.

TABLE 1

| | | | | Amount of mass | Amount | | Temperature |
|---|---|---|---|---|---|---|---|
| | | | Melting | reduction | of wax | Surface | of toner |
| | Product | | point | at 165° C. | charged | treatment | dispersion |
| | Name | Manufacturer | (° C.) | (% by mass) | (parts) | step | liquid (T1)(° C.) |
| Ex. 1-1 | VICTORY | TOYO ADL | 52 | 2.2 | 4 | performed | 60 |
| | WAX | CORPORATION | | | | | |
| Ex. 1-2 | BE SQUARE | TOYO ADL | 60 | 1.3 | 4 | performed | 60 |
| | 185 WAX | CORPORATION | | | | | |
| Ex. 1-3 | BE SQUARE | TOYO ADL | 77 | 0.7 | 4 | performed | 60 |
| | 195 WAX | CORPORATION | | | | | |
| Ex. 1-4 | BE SQUARE | TOYO ADL | 60 | 1.3 | 1.5 | performed | 70 |
| | 185 WAX | CORPORATION | | | | | |
| Ex. 1-5 | BE SQUARE | TOYO ADL | 60 | 1.3 | 8 | performed | 70 |
| | 185 WAX | CORPORATION | | | | | |
| Ex. 1-6 | BE SQUARE | TOYO ADL | 60 | 1.3 | 4 | performed | 73 |
| | 185 WAX | CORPORATION | | | | | |
| Comp. | paraffin | NIPPON SEIRO | 75 | 12 | 4 | performed | 60 |
| Ex. 1-1 | HNP-10 | CO., LTD. | | | | | |
| Comp. | LUVAX2191 | NIPPON SEIRO | 83 | 14 | 4 | performed | 60 |
| Ex. 1-2 | | CO., LTD. | | | | | |
| Comp. | VICTORY | TOYO ADL | 52 | 2.2 | 10 | performed | 60 |
| Ex. 1-3 | WAX | CORPORATION | | | | | |
| Comp. | BE SQUARE | TOYO ADL | 60 | 1.3 | 4 | performed | 40 |
| Ex. 1-4 | 185 WAX | CORPORATION | | | | | |
| Comp. | BE SQUARE | TOYO ADL | 60 | 1.3 | 4 | performed | 95 |
| Ex. 1-5 | 185 WAX | CORPORATION | | | | | |

The fixing properties of toner, filming resistance, back surface smear of printing paper, transfer efficiency, transfer unevenness, and fogging of each of the toners produced in Example 1-1 to Example 1-6 and Comparative Example 1-1 to Comparative Example 1-5 were evaluated. The results are shown in Table 2. The fixing properties of toner, filming resistance, back surface smear of printing paper, transfer efficiency, transfer unevenness, and fogging of each toner were evaluated under the following conditions.

TABLE 2

| | | Ex. | Ex. | Ex. | Ex. | Ex. | Ex. | Comp. | Comp. | Comp. | Comp. | Comp. |
|---|---|---|---|---|---|---|---|---|---|---|---|---|
| | | 1-1 | 1-2 | 1-3 | 1-4 | 1-5 | 1-6 | Ex. 1-1 | Ex. 1-2 | Ex. 1-3 | Ex. 1-4 | Ex. 1-5 |
| BET specific surface | | 3.1 | 2.0 | 2.9 | 3.3 | 1.8 | 1.1 | 2.3 | 2.2 | 2.1 | 3.5 | 0.9 |
| area of toner Sbet (m2/g) | | | | | | | | | | | | |
| Average circularity SF | | 0.96 | 0.94 | 0.97 | 0.96 | 0.97 | 0.97 | 0.95 | 0.95 | 0.96 | 0.94 | 0.98 |
| Sbet/SF (m2/g) | | 3.2 | 2.1 | 3.0 | 3.4 | 1.9 | 1.1 | 2.4 | 2.3 | 2.2 | 3.7 | 0.9 |
| Toner particle size (μm) | | 4.8 | 5 | 4.2 | 5.4 | 4.5 | 5 | 5.2 | 8.2 | 6.1 | 8.2 | 6.3 |
| Wax amount (% by mass) | | 3.5 | 3.3 | 3.7 | 1.3 | 7.8 | 3.2 | 3.9 | 3.5 | 9.2 | 3.5 | 9.2 |
| Fixing | Minimum | A | A | A | A | A | A | A | D | C | D | C |
| properties | Hot offset | B | B | B | B | B | A | B | B | B | B | B |
| | resistance | | | | | | | | | | | |

| | | | | | | | | | | | |
|---|---|---|---|---|---|---|---|---|---|---|---|
| Filming resistance | B | B | B | B | B | B | D | D | D | D | D |
| Back surface smear of | A | A | A | A | B | A | D | D | D | D | D |
| printing paper | | | | | | | | | | | |
| Transfer efficiency | B | B | B | B | B | B | B | B | B | B | D |
| Transfer unevenness | A | A | A | A | A | B | A | A | A | A | D |
| Fogging | A | A | A | A | A | B | A | A | A | A | B |

### (Fixing Properties)

The fixing properties of the toner was evaluated as follows. Evaluation was performed using a modified machine of IMAGIO NEO 450 in which a belt heat fixing unit shown in FIG. 5 manufactured by Ricoh Company, Ltd. was mounted. A belt heat fixing unit 25 shown in FIG. 5 included a heat roller R3 having a heat source H1 in a core, an endless fixing belt 26 stretched around a fixing roller R1 and the heat roller R3, and a pressurization roller 27 which was pressed via the fixing belt 26 to the fixing roller R1 by means of a pressurization spring P1. The pressurization roller 27 had a heat source H2 in a core for heating a recording medium P which was guided with a guide G, so as to heat and pressurize a toner on the recording medium P. A predetermined tension was applied to the fixing belt 26 by stretching the heat roller R3 with a spring P2, and the fixing belt 26 was slidingly in contact with an outer surface of a cleaning roller R4 for cleaning a surface of the fixing belt 26. In this Example, the fixing belt 26 basically had a three-layered belt having a 100 μm-thick polyimide as a base material, a 100 μm-thick silicone rubber as an intermediate elastic layer, and a 15 μm-thick PFA as an offset prevention layer as the surface layer. An outer periphery layer of the fixing roller R1 was formed of silicone foam, and the pressurization roller 27 had a metal cylinder as a core formed of SUS having a thickness of 1 mm, an offset prevention layer as the outermost periphery layer formed of a PFA tube and a silicone rubber and having a thickness of 2 mm, and an intermediate layer formed of aluminum having a thickness of 2 mm, and a surface pressure of 1×10⁵ Pa.

The evaluation criteria of properties are as follows.

### (1) Low-Temperature Fixing Ability (5-Scale Evaluation)

A: less than 120° C.

B: 120° C. to less than 130° C.

C: 130° C. to less than 140° C.

D: 140° C. to less than 150° C.

E: 150° C. or more

### (2) Hot Offset Resistance (5-Scale Evaluation)

A: 201° C. or more

B: 191° C. or more to less than 201° C.

C: 181° C. or more to less than 191° C.

D: 171° C. or more to less than 181° C.

E: less than 171° C.

### (Filming Resistance)

Using a color electrophotographic apparatus (IPSIO COLOR8100, manufactured by Ricoh Company, Ltd.), 50,000 sheets were copied. The presence or absence of toner filming on the developing roller or the photoconductor immediately after the copying was visually observed and evaluated based on the following criteria:

### Evaluation Criteria

A: No toner filming was observed.

B: Streaky toner filming was hardly observed.

C: Streaky toner filming was partly observed.

D: Toner filming was observed all over the developing roller or photoconductor.

### (Back Surface Smear of Printing Paper)

Using IMAGIO NEO 450 (manufactured by Ricoh Company, Ltd.), 1,000,000 sheets of black images were printed out, and thereafter a white solid image was printed out, and then a back surface smear of printing paper was evaluated based on the following evaluation criteria.

A: No back surface smear was observed.

B: Between A and C

C: Back surface smear was slightly observed.

D: Between C and E

E: Back surface smear was distinctly observed.

### (Transfer Efficiency (%)) (Transfer Rate)

An evaluation machine, which was a modified machine of DOCUCOLOR 8000 DIGITAL PRESS manufactured by Fuji Xerox Co., Ltd. and subjected to tuning so that the linear velocity and the transfer time could be adjusted, was provided. Each developer was subjected to a running test with the evaluation machine in which a solid image pattern of size A4 at a toner coverage of 0.6 mg/cm² was outputted as a test image. After outputting of 100,000 sheets of the test image and after outputting of 1,000,000 sheets of the test image, the transfer efficiency in the primary transfer and the transfer efficiency in the secondary transfer were determined respectively by Equation (3) and Equation (4), respectively. The evaluation criteria are as follows.

Primary transfer efficiency (%)=(amount of toner transferred onto intermediate transfer medium/amount of toner transferred on electrophotographic photoconductor)×100 Equation (3)

Secondary transfer efficiency (%)=(amount of toner transferred onto intermediate transfer medium−amount of toner remaining untransferred on the intermediate transfer medium/amount of toner transferred onto the intermediate transfer medium)×100 Equation (4)

The evaluation criteria are as follows.

A: 90% or more

B: 85% or more to less than 90%

C: 80% or more to less than 85%

D: Less than 80%

### (Transfer Unevenness)

Using a tandem color electrophotographic apparatus IMAGIO NEO 450 (manufactured by Ricoh Company, Ltd.), a black solid image was formed, and then the presence or absence of the transfer unevenness of the image was visually observed, and evaluated based on the following evaluation criteria.

A: No transfer unevenness was observed, and excellent image.

B: No transfer unevenness was observed, and no problem for practical use.

C: Transfer unevenness was slightly observed but acceptable for practical use.

D: Transfer unevenness was observed and unacceptable for practical use.

### (Fogging)

Using a tandem color electrophotographic apparatus IMAGIO NEO 450 (manufactured by Ricoh Company, Ltd.), which contained each of the toners and employed a cleaning blade and a charging roller each being in contact with a photoconductor, 100,000 sheets of an image pattern A were formed. The image pattern A was a lateral A4-size chart in which black solid images and white solid images were alternately arranged at intervals of 1 cm in a direction vertical to a direction of rotation of a developing sleeve. Subsequently, a white solid image was printed out and visually observed whether or not fogging occurred. Evaluation criteria are as follows:

A: No fogging was observed, and excellent quality.

B: Fogging was hardly observed, and no problem for practical use.

C: Fogging was slightly observed, but acceptable for practical use.

D: Fogging was observed, and unacceptable for practical use.

As can be seen from the results of Tables 1 and 2, when waxes of Comparative Examples 1-1 and 1-2, in which the mass reduction at 165° C. were respectively 12% and 14%, were used, the evaluation of the filming resistance and back surface smear of printing paper were poor. Since the wax of Comparative Example 1-2 had a melting point of 83° C., which was higher than 78° C., the minimum fixing temperature of the fixing properties was poor. When the amount of the wax charged in the toner of Comparative Example 1-3 was 10 parts but the wax content was 9.2%, the filming resistance and back surface smear of printing paper were poor. Since the wax of Comparative Example 1-4 had Sbet/SF of 3.7 m²/g, which was larger than 3.6 m²/g, not only the minimum fixing temperature of the fixing ability was poor, but also the filming resistance and back surface smear of printing paper were poor. Since the toner of Comparative Example 1-5 had Sbet/SF of 0.9 m²/g, which was smaller than 1.0 m²/g, it was clear that not only the filming resistance and back surface smear of printing paper were poor, but also the transfer efficiency and transfer unevenness were poor.

On the other hand, since in Example 1-1 to Example 1-6 of the present invention, the melting point, the amount of mass reduction at 165° C., the amount of the wax charged, the temperature of the toner dispersion liquid were within a predetermined range, it is apparent that the fixing properties, filming resistance, back surface smear of printing paper, transfer efficiency, and fogging exhibited excellent properties.

Next, the toner in which the temperature of the toner dispersion liquid (T1) was adjusted to 60° C., and the hold time was changed, was described based on Example 2-1, Example 2-2, Comparative Example 2-1 and Comparative Example 2-2.

### Example 2-1

### Synthesis of Unmodified Polyester (Low Molecular Mass Polyester)

A reaction vessel equipped with a reflux condenser, stirrer and gas inlet tube was charged with 229 parts of bisphenol A ethylene oxide (2 mol) adduct, 529 parts of bisphenol A propylene oxide (3 mol) adduct, 209 parts of terephthalic acid, 45 parts of adipic acid and 2 parts of dibutyltin oxide, and reacted for 7 hours at 230° C. under normal pressure. After the reaction liquid was reacted for 5 hours under reduced pressure of 10 mmHg to 15 mmHg, 43 parts of trimellitic anhydride was added in the reaction vessel and reacted for 2 hours at 180° C. under normal pressure to synthesize unmodified polyester. Unmodified polyester thus obtained had a number-average molecular mass (Mn) of 2,600, mass-average molecular mass (Mw) of 6,700, glass transition temperature (Tg) of 44° C., and acid value of 26 mgKOH/g.

### —Preparation of Master Batch (MB-2)—

In a reaction vessel, 1,200 parts of water, 540 parts of carbon black (Printex 35, manufactured by Degussa Co., DBP oil absorption=42 mL/100 g, pH=9.5), and 1,200 parts of the synthesized unmodified polyester were added and mixed with HENSCHEL MIXER (manufactured by Mitsui Mining Co., Ltd.). The obtained mixture was kneaded for 30 minutes at 170° C. using two rolls, and thereafter rolled and cooled, and milled with a pulverizer (manufactured by Hosokawa Micron Corporation) to prepare a master batch (MB-2).

### —Preparation of Wax Dispersion Liquid (2-1)—

In a reaction vessel equipped with a stirring rod and a thermometer, 378 parts of the synthesized unmodified polyester, 110 parts of a paraffin wax (VICTORY WAX manufactured by TOYO ADL CORPORATION; a melting point of 52° C.), 49.5 parts of a wax dispersant, and 947 parts of ethyl acetate were charged, and heated at 80° C. while stirring, and kept at 80° C. for 7 hours. Thereafter, the resultant product was cooled to 30° C. for 2 hours, to thereby obtain wax dispersion liquid (2-1).

### —Preparation of Organic Solvent Phase—

The prepared wax dispersion liquid (2-1) in an amount equivalent to 4.0 parts of the pigment contained in the toner was charged together with 500 parts of the prepared master batch (MB-2), and 500 parts of ethyl acetate, followed by mixing for 2 hours to thereby obtain a material solution.

The resultant material solution (1,325 parts) was placed in a reaction vessel, and the carbon black and the wax were dispersed by using a bead mill (“Ultra Visco Mill” by Imex Co., Ltd.) under conditions of a liquid feed rate of 1 kg/hr, disc circumferential velocity of 8 m/s, 0.5 mm zirconia beads packed to 80% by volume, and 3 passes. Then, 1,323 parts of 65% ethyl acetate solution of the synthesized unmodified polyester was added in the dispersion liquid. The resultant mixture was dispersed by using a bead mill (“Ultra Visco Mill” by Imex Co., Ltd.) under conditions of a liquid feed rate of 1 kg/hr, disc circumferential velocity of 8 m/s, 0.5 mm zirconia beads packed to 80% by volume, and 1 pass, to thereby prepare an organic solvent phase.

The resultant organic solvent phase had 50% in a solid content concentration (measurement condition: heating at 130° C. for 30 minutes).

### —Synthesis of Prepolymer—

In a reaction vessel equipped with a cooling tube, a stirrer and a nitrogen inlet tube, 681 parts of a bisphenol A ethylene oxide (2 mol) adduct, 83 parts of a bisphenol A propylene oxide (2 mol) adduct, 283 parts of terephthalic acid, 20 parts of trimellitic anhydride and 2 parts of dibutyltin oxide were loaded, and reacted under normal pressure at 230° C. for 9 hours. Subsequently, the resultant mixture was reacted for 5 hours under reduced pressure of 10 mmHg to 15 mmHg to obtain an intermediate polyester 2-1. The obtained intermediate polyester 2-1 had a number average molecular mass of 2,300, a mass average molecular mass of 9,800, peak molecular mass of 3,300, a glass transition temperature (Tg) of 56° C., an acid value of 0.4 mgKOH/g, and a hydroxyl value of 49 mgKOH/g.

Then, in a reaction vessel equipped with a cooling tube, a stirrer, and a nitrogen inlet tube, 411 parts of the intermediate polyester 2-1, 84 parts of isophorone diisocyanate, and 500 pars of ethyl acetate were loaded, and reacted for 6 hours at 100° C. to obtain a prepolymer 2-1. The obtained prepolymer 2-1 had 1.43% of a free isocyanate.

### —Synthesis of Ketimine (Compound Containing an Active Hydrogen Group)—

In a reaction vessel equipped with a stirring rod and a thermometer, 170 parts of isophorone diamine and 77 parts of methyl ethyl ketone were charged, and reacted for 7 hours at 50° C. to synthesize a ketimine compound (compound containing an active hydrogen group). The obtained ketimine compound (active hydrogen group-containing compound) had an amine value of 419.

### —Preparation of Toner Material Liquid—

In a reaction vessel, 749 parts of the organic solvent phase, 117 parts of the synthesized prepolymer, and 2.3 parts of the ketimine compound were charged, and mixed using a TK HOMOMIXER (manufactured by PRIMIX Corporation) at 8.5 m/s for 1 minute, to thereby prepare a toner material liquid.

### —Preparation of Organic Resin Fine Particle Dispersion Liquid—

Into a reaction vessel equipped with a stirring rod and a thermometer, 683 parts of water, 20 parts of a sodium salt of a sulfate ester of methacrylic acid ethylene oxide adduct (ELEMINOL RS-30, manufactured by Sanyo Chemical Industries Ltd.), 75 parts of styrene, 73 parts of methacrylic acid, 121 parts of butyl acrylate, and 1 part of ammonium persulfate were charged, and stirred at 400 rpm for 25 minutes to obtain a white emulsion. The emulsion was heated at a system temperature of 75° C. and then reacted for 5 hours. Further, 30 parts of a 1% aqueous ammonium persulfate solution was mixed thereto, and the resultant mixture was matured at 75° C. for 8 hours to prepare an aqueous dispersion liquid (an organic resin fine particle dispersion liquid) of vinyl resin particles (a copolymer of styrene-methacrylic acid-butyl acrylate-a sodium salt of a sulfate ester of methacrylic acid ethylene oxide adduct).

The volume average particle diameter (Dv) of the organic resin fine particles contained in the prepared organic resin fine particle dispersion liquid was measured by a particle size distribution measurement device (nanotrac UPA-150EX, manufactured by Nikkiso Co., Ltd.), and it was 55 nm. Further, a part of the organic resin fine particle dispersion liquid was dried to isolate a resin content. The resin content had a glass transition temperature (Tg) of 49° C., and a mass average molecular mass (Mw) of 452,000.

### —Preparation of Aqueous Medium—

Water (990 parts), 38 parts of an aqueous solution of 46.5% dodecyldiphenyl ether sodium disulfonate (ELEMINOL MON-7, manufactured by Sanyo Chemical Industries Ltd.), 15 parts of the prepared organic resin fine particle dispersion liquid, and 90 parts of ethyl acetate were mixed and stirred to prepare an opaque white liquid. The resultant product was an aqueous medium.

### —Emulsification or Dispersion—

The prepared aqueous medium (1,200 parts) was added to the prepared toner material liquid, and mixed using TK HOMOMIXER (manufactured by PRIMIX Corporation) for 40 minutes at a circumferential speed of 15 m/s to prepare a O/W dispersion liquid (emulsion slurry).

### —Removal of Organic Solvent—

In a reaction vessel equipped with a stirrer and thermometer, the emulsion slurry was placed after the emulsification or dispersion step (i.e. particle size was controlled), a solvent was removed at 30° C. for 8 hours, and maturation was effected at 45° C. for 5 hours to produce a dispersion slurry.

### —Washing and Drying—

After 100 parts of the dispersed slurry was filtrated under reduced pressure, washing and drying were performed as follows:

(i) One hundred (100) parts of ion-exchanged water was added to the filter cake, mixed using the TK HOMOMIXER at a rotational frequency of 10.0 m/s for 30 minutes and subsequently filtered.

(ii) One hundred (100) parts of ion-exchanged water was added to the filter cake of (i), mixed using the TK HOMOMIXER at a rotational frequency of 10.0 m/s for 10 minutes and subsequently filtered under reduced pressure.

(iii) One hundred (100) parts of a 10% sodium hydroxide aqueous solution was added to the filter cake of (ii), mixed using the TK HOMOMIXER at a rotational frequency of 10.0 m/s for 10 minutes and subsequently filtered.

(iv) Three hundred (300) parts of ion-exchanged water was added to the filter cake of (iii), mixed using the TK HOMOMIXER at a rotational frequency of 10.0 m/s for 30 minutes and subsequently filtered. These operations were performed twice to obtain the final filter cake.

### —Surface Treatment Step—

To the resultant filter cake in the washing, 300 parts of ion-exchanged water was added, and stirred with the TK HOMOMIXER at 8,000 rpm, to thereby produce a toner dispersion liquid. The toner dispersion liquid was heated, and the temperature T1 (T1=55° C.) was held for 5 minutes, and then the toner dispersion was cooled. Thereafter, conductivity of the toner dispersion liquid was measured. Based on the calibration curve of the surfactant concentration, which had been obtained in advance, the surfactant concentration of the toner dispersion liquid was calculated as 0.04%. Next, filtration was performed.

### —Drying—

The resultant final filter cake was dried by a circular wind dryer at 45° C. for 48 hours, and sieved with a mesh having 75 μm openings to obtain toner base particles of Example 2-1.

### —External Additive Treatment—

To the resultant toner base particles of Example 2-1 (100 parts), 1.8 parts of hydrophobic silica as an external additive and 0.7 parts of hydrophobic titanium oxide were added and mixed using HENSCHEL MIXER (manufactured by Mitsui Mining Co., Ltd.). The mixture was sieved with a mesh having 35 μm openings, to thereby produce a toner of Example 2-1. The volume average particle diameter (Dv), number average particle diameter (Dn), particle size distribution (volume average particle diameter (Dv)/number average particle diameter (Dn)) of the resultant toner were measured.

### Example 2-2

A toner of Example 2-2 was produced in the same manner as in Example 2-1, except that the time for holding the temperature of the toner dispersion liquid in the surface treatment step was changed from 5 minutes to 55 minutes.

### Comparative Example 2-1

A toner of Comparative Example 2-1 was produced in the same manner as in Example 2-1, except that the time for holding the temperature of the toner dispersion liquid in the surface treatment step was changed from 5 minutes to 30 seconds.

### Comparative Example 2-2

A toner of Comparative Example 2-2 was produced in the same manner as in Example 2-1, except that the time for holding the temperature of the toner dispersion liquid in the surface treatment step was changed from 5 minutes to 70 minutes.

The times for holding the temperature of the toner dispersion liquid in the surface treatment step of Example 2-1, Example 2-2, Comparative Example 2-1 and Comparative Example 2-2 are shown in Table 3.

TABLE 3

| | Time for holding temperature of | |
|---|---|---|
| | toner dispersion liquid (T1) | |
| Example 2-1 | 5 | minutes |
| Example 2-2 | 55 | minutes |
| Comparative Example 2-1 | 30 | seconds |
| Comparative Example 2-2 | 70 | minutes |

The BET specific surface area (Sbet) of toner, average circularity (SF), Sbet/SF, toner particle diameter, wax amount, fixing properties (minimum, hot offset resistance), filming resistance, back surface smear of printing paper, transfer efficiency, transfer unevenness, fogging of each of the toners of Example 2-1, Example 2-2, Comparative Example 2-1 and Comparative Example 2-2 were measured and evaluated in the same manner as in Example 1-1 to Example 1-6. The results are shown in Table 4.

TABLE 4

| | | | | Comp. Ex. | Comp. Ex. |
|---|---|---|---|---|---|
| | | Ex. 2-1 | Ex. 2-2 | 2-1 | 2-2 |
| BET specific surface area of | | 2.8 | 1.2 | 3.7 | 0.9 |
| toner Sbet (m²/g) | | | | | |
| Average circularity SF | | 0.95 | 0.97 | 0.93 | 0.98 |
| Sbet/SF (m²/g) | | 2.9 | 1.2 | 4.0 | 0.9 |
| Toner particle size (μm) | | 5.2 | 5.1 | 4.9 | 5.3 |
| Wax amount (% by mass) | | 3.5 | 3.3 | 3.7 | 3.5 |
| Fixing | Minimum | A | A | A | D |
| properties | Hot offset | B | B | B | B |
| | resistance | | | | |

| | | | | |
|---|---|---|---|---|
| Filming resistance | B | B | D | D |
| Back surface smear of | A | A | D | D |
| printing paper | | | | |
| Transfer efficiency | B | B | D | D |
| Transfer un-evenness | A | B | D | D |
| Fogging | A | A | D | D |

In the toner of Example 2-1, the wax bleeding is suppressed, thus wax contamination of the components other than the toner less occurred. Thus, the toner of Example 2-1 was superior to other toners in all of the filming resistance, back surface smear of printing paper, transfer efficiency, transfer unevenness, and fogging. On the other hand, since the heat time of the toner of Comparative Example 2-1 was short, the toner surface was not sufficiently smoothed, causing poor transfer efficiency, transfer unevenness, and fogging. With regard to the toner of Comparative Example 2-2, the toner surface was smoothed, but contamination of the components other than the toner, which might be caused by wax bleeding, was observed, and the filming resistance, back surface smear of printing paper, transfer efficiency, transfer unevenness, and fogging decreased.

Each of the melt viscosity at 140° C. of the wax used in Examples is shown in Table 5.

TABLE 5

| | Melt viscosity at 140° C. |
|---|---|
| Product Name | (mPa · s) |
| VICTORY WAX | 12 |
| BE SQUARE 185 WAX | 9 |
| BE SQUARE 195 WAX | 10 |
| paraffin HNP-10 | 4 |
| LUVAX2191 | 19 |

What is claimed is:

1. A toner comprising:
a binder;
a colorant; and
a wax having a molecular chain consisting of C—H bond and C—C bond,
wherein the mass reduction of the wax at 165° C. is 10% by mass or less, and the total amount of the wax in the toner measured by a DSC method is 1% by mass to 8% by mass,
wherein a ratio, Sbet/SF, of a BET specific surface area (Sbet) of the toner to an average circularity (SF) of the toner is 1.0 m²/g or more to less than 3.6 m²/g,
wherein the toner is obtained through a process which comprises at least emulsifying or dispersing a toner material liquid in an aqueous medium containing a surfactant, and
wherein the toner material liquid is a liquid containing toner-forming materials which comprise at least the binder, the colorant and the wax.

2. The toner according to claim 1, wherein the wax has a melting point of 50° C. to 90° C.

3. The toner according to claim 2, wherein the wax has a melting point of 52° C. to 77° C.

4. The toner according to claim 1, wherein the wax in the toner has a melt viscosity at 140° C. of 6 mPa·s to 15 mPa·s.

5. The toner according to claim 1, wherein the mass reduction of the wax at 165° C. is 3% by mass or less.

6. The toner according to claim 1, wherein the mass reduction of the wax at 165° C. is 2.2% by mass or less.

7. The toner according to claim 1, wherein the wax is microcrystalline wax.

8. The toner according to claim 1, further comprising 40% by mass to 80% by mass of a wax dispersant relative to the wax.

9. The toner according to claim 1, wherein the toner material contains a binder resin or a precursor of the binder resin as a component of the binder.

10. The toner according to claim 9, wherein the precursor of the binder resin is a compound containing an active hydrogen group and a polymer reactive with the active hydrogen group, and the toner comprises a reaction product obtained by reacting the compound with the polymer in the emulsifying or dispersing the toner material liquid in the aqueous medium.

11. The toner according to claim 9, wherein the toner-forming materials comprise a polyester resin as the binder resin.

12. A process cartridge comprising:
a latent electrostatic image bearing member; and
a developing unit,
wherein the latent electrostatic image bearing member and the developing unit are integrally supported, and the process cartridge is detachably mounted to a main body of an image forming apparatus,
wherein the developing unit contains a toner, which is supplied to a latent electrostatic image on the latent electrostatic image bearing member so as to form a toner image,
wherein the toner contains:
a binder;
a colorant; and
a wax having a molecular chain consisting of C—H bond and C—C bond,
wherein the mass reduction of the wax at 165° C. is 10% by mass or less, and the total amount of the wax in the toner measured by a DSC method is 1% by mass to 8% by mass,
wherein a ratio, Sbet/SF, of a BET specific surface area (Sbet) of the toner to an average circularity (SF) of the toner is 1.0 m²/g or more to less than 3.6 m²/g,
wherein the toner is obtained through a process which comprises at least emulsifying or dispersing a toner material liquid in an aqueous medium containing a surfactant, and
wherein the toner material liquid is a liquid containing toner-forming materials which comprise at least the binder, the colorant and the wax.

13. A method for producing a toner, comprising:
emulsifying and dispersing a toner material liquid in an aqueous medium containing a surfactant so as to form a toner dispersion liquid; and
heating the toner dispersion liquid at a temperature (T1) of 45° C. to 90° C. so as to treat a surface of a toner particle,
wherein the toner comprises:
a binder;
a colorant; and
a wax having a molecular chain consisting of C—H bond and C—C bond,
wherein the mass reduction of the wax at 165° C. is 10% by mass or less, and the total amount of the wax in the toner measured by a DSC method is 1% by mass to 8% by mass,
wherein a ratio, Sbet/SF, of a BET specific surface area (Sbet) of the toner to an average circularity (SF) of the toner is 1.0 m²/g or more to less than 3.6 m²/g, and
wherein the toner material liquid is a liquid containing toner-forming materials which comprise at least the binder, the colorant and the wax.

14. The method for producing a toner according to claim 13, wherein, in the heating, the temperature (T1) of the toner dispersion liquid at 45° C. to 90° C. is held for 1 minute to 1 hour.

15. The method for producing a toner according to claim 13, wherein, in the heating, the concentration of the surfactant is 0.1 times or more to less than 2.0 times of the critical micelle concentration of the surfactant.
